(19) United States
(12) Patent Application Publication
(10) Pub. No.: US 2010/0134444 A1
(43) Pub. Date: Jun. 3, 2010

(54) IMAGE PROCESSING DEVICE, CONTROL PROGRAM, COMPUTER-READABLE STORAGE MEDIUM, ELECTRONIC APPARATUS, AND IMAGE PROCESSING DEVICE CONTROL METHOD

(76) Inventor: Yoichiro Yahata, Osaka (JP)

Correspondence Address: BIRCH STEWART KOLASCH & BIRCH, PO BOX 747, FALLS CHURCH, VA, 22040-0747, US

(21) Appl. No.: 12/593,897

(22) PCT Filed: Mar. 28, 2008
(86) PCT No.: PCT/JP2008/056220

§ 371 Date: Sep. 29, 2009

(30) Foreign Application Priority Data
Mar. 30, 2007 (JP) 2007-094993

(51) Int. Cl. G06F 3/041; G06K 9/62; G09G 3/36

(52) U.S. Cl. 345/175; 382/209; 345/87

(57) ABSTRACT

The invention includes: a pixel-value vertical-gradient-quantity calculation section (3a) and a pixel-value horizontal-gradient-quantity calculation section (3b) for calculating a vertical-direction gradient quantity (Sy) and a horizontal-direction gradient quantity (Sx) for a pixel value; a gradient direction/null direction identifying section (5) for identifying, for each pixel, either a gradient direction or null direction; a score calculation section (10) for calculating an correspondence degree for a matching region and a predetermined model pattern from a number of matches of a gradient direction for each pixel contained in the matching region with a gradient direction in the model pattern; a peak search section (12) for searching a search area for a peak pixel which is a pixel for which the correspondence degree calculated by the score calculation section (10) is a maximum; and a coordinate calculation section (14) for calculating a position in a captured image pointed at with an image capture object by using the correspondence degree for each pixel in a peak pixel region.

### TECHNICAL FIELD

The present invention relates to image processing devices having a function of identifying a position in a captured image pointed at with an image capture object by using image data for the captured image.

### BACKGROUND ART

It is well known that image display devices built around various devices, such as mobile phones or PDAs (Personal Digital Assistants), and equipped with a liquid crystal display device as an image display section (hereinafter, “liquid crystal display devices”) are in popular use. Especially, the PDA traditionally contains touch sensors to enable a touch input whereby the user can input information by directly touching the liquid crystal display device with, for example, a finger. It is expected that broad ranges of mobile phones and like devices will also adopt a liquid crystal display device which come with touch sensors.

Patent Literature 1 discloses technology as an example of the liquid crystal display device incorporating touch sensors.

This conventional liquid crystal display device primarily includes an edge detection circuit, a touch/non-touch determining circuit, and a coordinate calculation circuit. The edge detection circuit is adapted to detect an edge of a captured image to obtain an edge image.

The touch/non-touch determining circuit is adapted to determine from the edge image obtained by the edge detection circuit whether or not an object has touched a display screen. The touch/non-touch determining circuit is adapted to examine the direction of motion of each edge (temporal changes of the coordinates of each edge) of the object and if there are edges moving in opposite directions, determines that the object has touched the display screen. This is an exploitation of the fact that the edges do not move in opposite directions unless the object is in contact with something. Specifically, the circuit is adapted to improve precision in the determination by so determining when the amount of motion in opposite directions is greater than or equal to a predetermined threshold.

Furthermore, the coordinate calculation circuit is adapted to calculate the center of mass of the edge as the coordinate position of the object when the object is determined to have come in contact with the surface. The circuit is thus prevented from calculating the coordinate position before the object comes into contact, allowing for improvement of precision in the calculation of the position.

The conventional liquid crystal display device, however, needs to retain image data or edge data throughout two or more frames because the circuit uses the edges moving in opposite directions (object in an image changing with time) in order to detect a touch/non-touch.

The touch/non-touch detection thus requires information for at least two frames or even more, which in turn disadvantageously requires large memory.

Another problem is that the identification of the touch position is time-consuming because the device is adapted to calculate the center of mass of the edge as the coordinate position of the object when the object is determined to have come in contact with the surface so that the coordinate position of the object can be calculated after the touch/non-touch detection.

Furthermore, in the conventional liquid crystal display device, the amount of image processing can be possibly reduced to allow for reducing the time taken by the calculation of the coordinate position of the object, by reducing the resolution of the captured image. That will however entail another problem of poor precision in the coordinate position detection because the center of mass of the edge is calculated as the coordinate position of the object.

### Citation List

Patent Literature 1

Japanese Patent Application Publication, Tokukai, No. 2006-244446 (Publication Date: Sep. 14, 2006)

Patent Literature 2

Japanese Patent Application Publication, Tokukai, No. 2004-318819 (Publication Date: Nov. 11, 2004)

Patent Literature 3

Japanese Patent Application Publication, Tokukai, No. 2007-183706 (Publication Date: Jul. 19, 2007)

### SUMMARY OF INVENTION

The present invention, conceived in view of these conventional problems, has an objective of providing an image processing device, etc. capable of detection of a position in a captured image pointed at with an image capture object with small memory and short processing time by performing pattern matching using image data for only one frame, irrespective of detection of a touch/non-touch of the captured image with the image capture object, and also capable of both reduction in the amount of image processing in the calculation of the coordinate position and maintaining of precision in the coordinate position detection with small memory.

The image capture device in accordance with the present invention is, to address the problems, characterized in that it is an image processing device having a function of calculating a position in a captured image pointed at with an image capture object by using image data for the captured image, the device including:

gradient calculation means for calculating, for each pixel in the image data, a vertical-direction gradient quantity and a horizontal-direction gradient quantity for a pixel value of that pixel from the pixel value and pixel values of adjoining pixels;

gradient direction identifying means for identifying, for each pixel, either a gradient direction or null direction based on the vertical-direction gradient quantity and the horizontal-direction gradient quantity calculated by the gradient calculation means, the pixel having null direction if both the vertical-direction gradient quantity and the horizontal-direction gradient quantity or a gradient magnitude calculated from the vertical-direction gradient quantity and the horizontal-direction gradient quantity is less than a predetermined threshold;

correspondence degree calculation means for matching a matching region with a predetermined model pattern, the matching region being a region, around a target pixel, containing a predetermined number of pixels, and for calculating a number of pixels for which a gradient direction for each pixel in the matching region matches a gradient direction for each pixel in the model pattern as an correspondence degree which is a degree of matching of the matching region with the model pattern;

peak pixel search means for searching a search area containing a predetermined number of pixels around the target pixel for a peak pixel which is a pixel for which the correspondence degree calculated by the correspondence degree calculation means is a maximum; and

coordinate calculation means for calculating the position in the captured image pointed at with the image capture object by using the correspondence degree for each pixel in a peak pixel region which is a region containing a predetermined number of pixels centered around the peak pixel found by the peak pixel search means.

The method of controlling an image capture device in accordance with the present invention is characterized in that it is a method of controlling an image processing device having a function of calculating a position in a captured image pointed at with an image capture object by using image data for the captured image, the method including:

the gradient calculation step of calculating, for each pixel in the image data, a vertical-direction gradient quantity and a horizontal-direction gradient quantity for a pixel value of that pixel from the pixel value and pixel values of adjoining pixels;

the gradient direction identifying step of identifying, for each pixel, either a gradient direction or null direction based on the vertical-direction gradient quantity and the horizontal-direction gradient quantity calculated in the gradient calculation step, the pixel having null direction if both the vertical-direction gradient quantity and the horizontal-direction gradient quantity or a gradient magnitude calculated from the vertical-direction gradient quantity and the horizontal-direction gradient quantity is less than a predetermined threshold;

the correspondence degree calculation step of matching a matching region with a predetermined model pattern, the matching region being a region, around a target pixel, containing a predetermined number of pixels, and for calculating a number of pixels for which a gradient direction for each pixel in the matching region matches a gradient direction for each pixel in the model pattern as an correspondence degree which is a degree of matching of the matching region with the model pattern;

the peak pixel search step of searching a search area containing a predetermined number of pixels around the target pixel for a peak pixel which is a pixel for which the correspondence degree calculated by the correspondence degree calculation means is a maximum; and

the coordinate calculation step of calculating the position in the captured image pointed at with the image capture object by using the correspondence degree for each pixel in a peak pixel region which is a region containing a predetermined number of pixels centered around the peak pixel found in the peak pixel search step.

According to the configuration or method, the gradient calculation means or step calculates, for each pixel in the image data, a vertical-direction gradient quantity and a horizontal-direction gradient quantity for a pixel value of that pixel from the pixel value and pixel values of adjoining pixels.

The gradient direction identifying means or step identifies, for each pixel, either a gradient direction or null direction based on the vertical-direction gradient quantity and the horizontal-direction gradient quantity calculated by the gradient calculation means or in the gradient calculation step, the pixel having null direction if both the vertical-direction gradient quantity and the horizontal-direction gradient quantity or a gradient magnitude calculated from the vertical-direction gradient quantity and the horizontal-direction gradient quantity is less than a predetermined threshold.

Having null direction is defined here as “being less than a predetermined threshold.” Alternatively, it may be defined as “being less than or equal to a predetermined threshold.”

The advance labeling as “having null direction” limits occurrences of numerous unwanted gradient directions which would otherwise be caused by noise and other factors. The advance labeling also leads to reducing matching targets to gradient directions near the edge, allowing for more efficient matching.

The vertical-direction gradient quantity, the horizontal-direction gradient quantity, the gradient direction, the gradient magnitude, etc. for the pixel value are quantities obtained from a single-frame captured image. In addition, these quantities are obtainable irrespective of detection of a touch/non-touch of the captured image with the image capture object.

Next, the correspondence degree calculation means or step matches a matching region with a predetermined model pattern, the matching region being a region, around a target pixel, containing a predetermined number of pixels, and calculates an correspondence degree which is a degree of matching of the matching region with the model pattern from a number of pixels for which a gradient direction contained in the matching region matches a gradient direction contained in the model pattern.

A scalar quantity, such as a pixel value (density level), could possibly be used as the quantity used in the matching of a matching region with a predetermined model pattern (hereinafter, may be referred to as the “pattern matching”). It is however difficult to set up model patterns in advance because the scalar quantity, even when quantized (values within a predetermined range are treated by equally regarding them as a particular constant), is ever variable depending on, for example, the condition of the image capture object.

Meanwhile, the gradient of the pixel value is a vector quantity with both a magnitude (gradient magnitude) and a direction (gradient direction). Especially, the gradient direction (orientation), for example, when quantized into 8 directions, enables discretization of any potential states for the pixels with as few as 8 states (or 9 if null direction is included), which is an extremely small number. Furthermore, the discretized states render different directions readily distinguishable.

The gradient directions generally match a direction either from an edge part in the captured image to near the center of an area surrounded by the edge part or radially from near the center toward the edge part, for example, for the finger surface or like soft surface which forms a round contact face upon contact with another surface and for the round-tipped pen or like surface which forms a round contact face despite its hardness. For contact faces of other shapes, the gradient directions again generally match a direction either from an edge part in the captured image to the inside of an area surrounded by the edge part or from the inside of an area surrounded by an edge part toward the outside of the area. This tendency does not change much with the condition of the image capture object, for example. The gradient direction is hence a suitable quantity for pattern matching.

Hence, pattern matching using image data for only one frame becomes possible irrespective of detection of a touch/non-touch of the captured image with the image capture object. That in turn enables pattern matching with small memory and short processing time.

The peak pixel search means searches a search area containing a predetermined number of pixels around the target pixel for a peak pixel which is a pixel for which the correspondence degree calculated by the correspondence degree calculation means is a maximum.

According to the configuration, a search area containing a predetermined number of pixels is searched. Hence, the processing cost and the memory size are reduced when compared to searching the image data region containing the total pixel count for a peak pixel.

The coordinate calculation means calculates the position in the captured image pointed at with the image capture object by using the correspondence degree for each pixel in a peak pixel region which is a region containing a predetermined number of pixels centered around the peak pixel found by the peak pixel search means. For example, when the pointing position is to be obtained from the position of the center of mass of the edge image, the calculation would become increasingly difficult with deformation of the captured image.

However, in the image processing device in accordance with the present invention, the position in the captured image pointed at with the image capture object is calculated by using the correspondence degree for each pixel in the peak pixel region obtained by pattern matching. Even if the captured image is deformed, the neighborhood of a maximum of the correspondence degree in the pattern matching would be regarded as exhibiting a substantially similar tendency in distribution to the tendency before the deformation where the correspondence degree decreases radially from the neighborhood of the maximum.

Therefore, the position in the captured image pointed at with the image capture object can be calculated by predetermined procedures (for example, calculation of a center of mass for the correspondence degree in the peak pixel region) regardless of whether or not the captured image is deformed. Hence, the amount of image processing, the processing cost, and the memory size are all reduced in the calculation of the pointing position while maintaining precision in the coordinate position detection.

Hence, the image processing device, as an example, is provided which, irrespective of detection of a touch/non-touch of the captured image with the image capture object, can detect the position in the captured image pointed at with the image capture object with small memory and short processing time by performing the pattern matching using image data for only one frame and which can also both reduce the amount of image processing in the calculation of the coordinate position and maintain precision in the coordinate position detection with small memory.

Additional objectives, advantages and novel features of the invention will be set forth in part in the description which follows, and in part will become apparent to those skilled in the art upon examination of the following or may be learned by practice of the invention.

### BRIEF DESCRIPTION OF DRAWINGS

FIG. 1

FIG. 1 is a block diagram of an embodiment of the image processing device of the present invention.

FIG. 2

FIG. 2 is a schematic illustration of image capturing by the image processing device. FIG. 2(a) depicts image capturing for a finger pad in a dark environment. FIG. 2(b) depicts features in a captured image of the finger pad in a dark environment. FIG. 2(c) depicts image capturing for a finger pad in a bright environment. FIG. 2(d) depicts features in a captured image of the finger pad in a bright environment. FIG. 2(e) depicts image capturing for a pen tip in a dark environment. FIG. 2(f) depicts features in a captured image of the pen tip in a dark environment. FIG. 2(g) depicts image capturing for a pen tip in a bright environment. FIG. 2(h) depicts features in a captured image of the pen tip in a bright environment.

FIG. 3

FIG. 3 is a flow chart for the entire operation of the image processing device.

FIG. 4

FIG. 4 is a flow chart for a part of the operation of the image processing device, or a gradient direction/null direction identification process.

FIG. 5

FIG. 5 shows exemplary tables referenced in the gradient direction/null direction identification process. FIG. 5(a) shows an exemplary table. FIG. 5(b) shows another exemplary table.

FIG. 6

FIG. 6 is a schematic illustration of features in the gradient direction of image data. FIG. 6(a) depicts features in the gradient direction of image data in a dark environment.

FIG. 6(b) depicts the pattern shown in FIG. 6(a) after matching efficiency improvement.

FIG. 7

FIG. 7 is a schematic illustration of exemplary model patterns prior to matching efficiency improvement. FIG. 7(a) depicts an exemplary model pattern prior to matching efficiency improvement in a dark environment. FIG. 7(b) depicts an exemplary model pattern prior to matching efficiency improvement in a bright environment.

FIG. 8

FIG. 8 is a schematic illustration of exemplary model patterns subsequent to matching efficiency improvement.

FIG. 8(a) depicts an exemplary model pattern subsequent to matching efficiency improvement in a dark environment.

FIG. 8(b) depicts an exemplary model pattern subsequent to matching efficiency improvement in a bright environment.

FIG. 9

FIG. 9 is a schematic illustration of other exemplary model patterns subsequent to matching efficiency improvement. FIG. 9(a) depicts another exemplary model pattern subsequent to matching efficiency improvement in a dark environment. FIG. 9(b) depicts another exemplary model pattern subsequent to matching efficiency improvement in a bright environment.

FIG. 10

FIG. 10 is a flow chart for a part of the operation of the image processing device, or a pattern matching process.

FIG. 11

FIG. 11 is a schematic illustration of pattern matching between a matching region and a model pattern. FIG. 11(a) depicts exemplary pattern matching between a matching region and a model pattern in a dark environment prior to matching efficiency improvement. FIG. 11(b) depicts an exemplary correspondence degree calculation method for the pattern matching.

FIG. 12

FIG. 12 is a schematic illustration of exemplary pattern matching between a matching region and a model pattern. FIG. 12(a) depicts exemplary pattern matching between a matching region and a model pattern in a dark environment subsequent to matching efficiency improvement.

FIG. 12(b) depicts an exemplary correspondence degree calculation method for the pattern matching.

FIG. 13

FIG. 13 is a schematic illustration of other exemplary pattern matching between a matching region and a model pattern. FIG. 13(a) depicts other exemplary pattern matching between a matching region and a model pattern in a dark environment subsequent to matching efficiency improvement. FIG. 13(b) depicts an exemplary correspondence degree calculation method for the pattern matching.

FIG. 14

FIG. 14 is a flow chart for pattern matching in the image processing device where a matching pixel count and a pattern correspondence degree are used together.

FIG. 15

FIG. 15 is a flow chart for pattern correspondence degree calculation processes. FIG. 15(a) depicts an exemplary pattern correspondence degree calculation process.

FIG. 15(b) depicts another exemplary pattern correspondence degree calculation process.

FIG. 16

FIG. 16 is a schematic illustration of exemplary pattern correspondence degree calculation processes.

FIG. 16(a) depicts an exemplary pattern correspondence degree calculation process.

FIG. 16(b) depicts another exemplary pattern correspondence degree calculation process.

FIG. 16(c) depicts a further exemplary pattern correspondence degree calculation process.

FIG. 17

FIG. 17 is a schematic illustration of exemplary pattern correspondence degree calculation processes.

FIG. 17(a) depicts still another exemplary pattern correspondence degree calculation process.

FIG. 17(b) depicts yet another exemplary pattern correspondence degree calculation process.

FIG. 17(c) depicts further yet another exemplary pattern correspondence degree calculation process.

FIG. 18

FIG. 18 is a flow chart for a part of the operation of the image processing device, or a pointing position coordinate calculation process.

FIG. 19

FIG. 19 is a schematic illustration of the operation of a coordinate calculation determining section in the image processing device.

FIG. 19(a) depicts the operation in the case of the coordinate calculation determining section in the image processing device determining that there is no peak pixel.

FIG. 19(b) depicts the operation in the case of the coordinate calculation determining section in the image processing device determining that there is a peak pixel.

FIG. 20

FIG. 20 is a schematic illustration of calculation of a position in a captured image pointed at with an image capture object in the image processing device. FIG. 20(a) depicts a peak pixel region used for the calculation of a position in a captured image pointed at with an image capture object in the image processing device. FIG. 20(b) depicts an exemplary pointing position coordinate calculation method implemented by the image processing device.

### REFERENCE SIGNS LIST

1 Image Processing Device
2 Resolution Reduction Section
3a Pixel-value Vertical-gradient-quantity Calculation Section (Gradient Calculation Means)
3b Pixel-value Horizontal-gradient-quantity Calculation Section (Gradient Calculation Means)
4 Edge Extraction Section (Edge Pixel Identification Means, Touch/non-touch Determining Means)
5 Gradient Direction/ Null Direction Identifying Section (Gradient Direction Identifying Means)
6 Matching Efficiency Improving Section (Matching Efficiency Improving Means)
7 Matching Pixel Count Calculation Section (Correspondence degree Calculation Means)
8 Model Pattern And Comparative Matching Pattern Storage Section
9 Pattern Correspondence degree Calculation Section (Correspondence degree Calculation Means)
10 Score Calculation Section (Correspondence degree Calculation Means, Touch/non-touch Determining Means)
11 Position Identifying Section (Position Identifying Means)
12 Peak Search Section (Peak Pixel Identifying Means, Position Identifying Means)
13 Coordinate Calculation Determining Section (Coordinate Calculation Determining Means, Position Identifying Means)
14 Coordinate Calculation Section (Coordinate Calculation Means, Position Identifying Means)
20 Electronic Apparatus
61 to 64 Captured Image
Sx Horizontal-direction Gradient Quantity
Sy Vertical-direction Gradient Quantity
ABS(S) Gradient Magnitude
ANG(S) Gradient Direction

### DESCRIPTION OF EMBODIMENTS

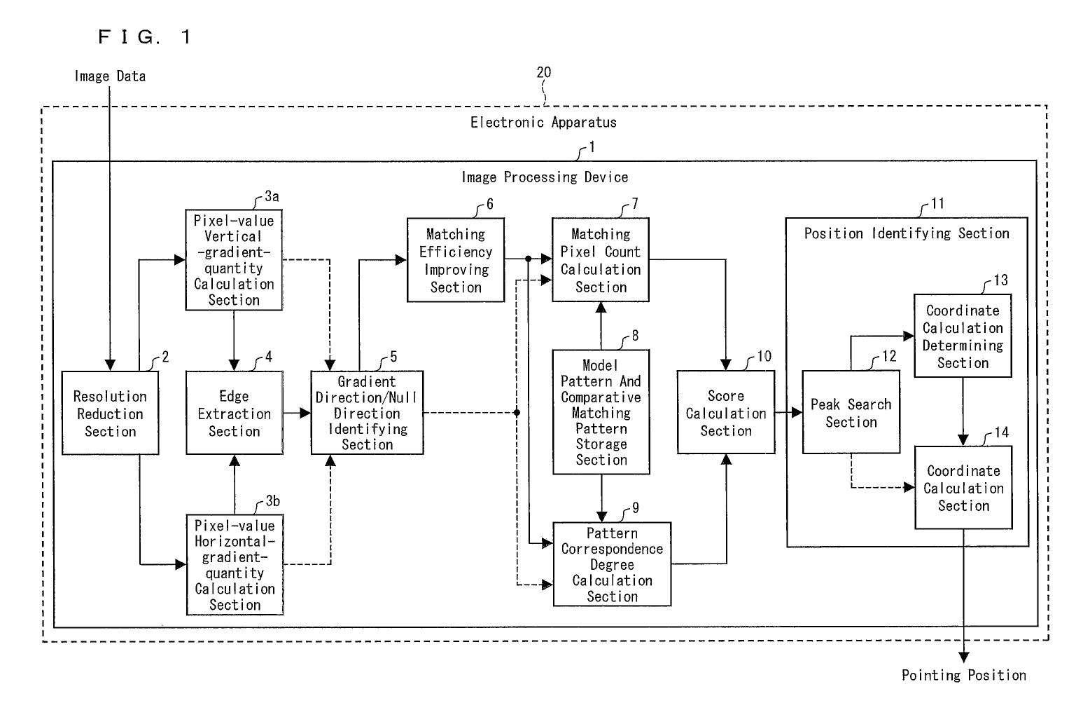

The following will describe an embodiment of the present invention in reference to FIGS. 1 to 11. The present embodiment employs a liquid crystal display device as an exemplary image display section. The present invention is however also applicable to image display sections that are not liquid crystal display devices.
1. Configuration of Image Processing Device (Electronic Apparatus)

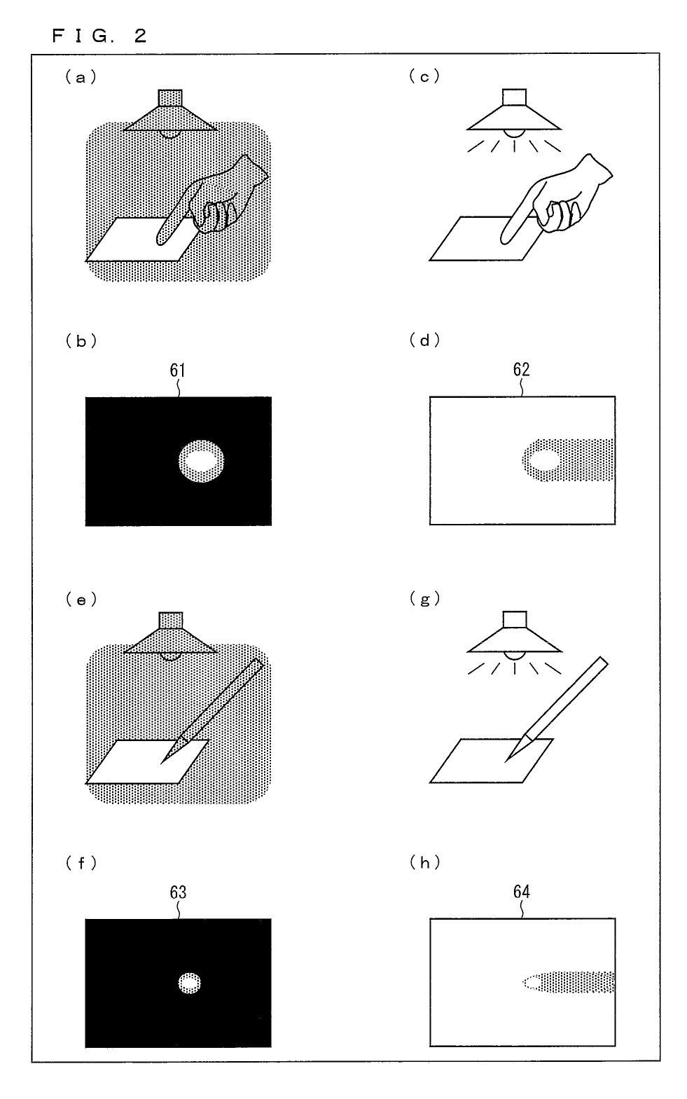

First, referring to FIGS. 1 and 2(a) to 2(h), the configuration of an image processing device 1 (electronic apparatus 20) which is an embodiment of the present invention and an exemplary captured image will be described. Although the following description will be focused on the image processing device 1 for convenience, the present embodiment is applicable to general electronic apparatus provided that the apparatus is electronic apparatus (electronic apparatus 20) which needs the functions of the image processing device 1 which is an embodiment of the present invention.

First, an overview of the configuration of the image processing device 1 and an image capturing mechanism for the image processing device 1 will be described. The image processing device 1 is similar to general liquid crystal display devices in that the former has a display function and includes a liquid crystal display device (display device) containing a plurality of pixels and a backlight illuminating the liquid crystal display device.

The liquid crystal display device in the image processing device 1 differs from general liquid crystal display devices in that the former contains a built-in light sensor (image capture sensor) in each pixel so that it can capture, by the light sensors, an image of, for example, an external object (image capture object) approaching the display screen of the liquid crystal display device and acquire as image data (image data produced by the image capture sensors).

The liquid crystal display device may contain a built-in light sensor in each of a predetermined number of all the pixels. Preferably, however, each of all the pixels includes a built-in light sensor for better captured image resolution obtained with the light sensors.

The liquid crystal display device in the image processing device 1, as in a general liquid crystal display device, includes a display section containing a plurality of scan lines and a plurality of signal lines intersecting the plurality of scan lines, pixels with various capacitances formed at the intersections, and thin film transistors and further includes driver circuits driving the scan lines and driver circuits driving the signal lines.

The liquid crystal display device in the image processing device 1 is adapted to contain a built-in photodiode (image capture sensor) in, for example, each pixel as an image capture sensor. The photodiode is connected to a capacitor and adapted to change the electric charge of the capacitor according to changes in quantity of the light that is incident to the display screen and received by the photodiode. Voltage across both ends of the capacitor is detected to generate image data for image capturing (acquiring). This is the image capturing mechanism by the liquid crystal display device in the image processing device 1.

The image capture sensor is not limited to a photodiode and may be anything that relies on photoelectric effect for its operation and that can be built in each pixel in, for example, the liquid crystal display device.

In this configuration, the image processing device 1 is adapted to have, in addition to an inherent display function by which the liquid crystal display device displays images, an image capture function by which the display device captures images of an external object (image capture object) approaching the display screen. The image processing device can hence be adapted to enable a touch input on the display screen of the display device.

Now, referring to FIG. 2(a) to FIG. 2(h), features in captured images (or image data) will be briefly described by taking examples of a finger pad and a pen tip as examples of the image capture object of which an image is captured by the built-in photodiodes in the pixels of the liquid crystal display device in the image processing device 1.

FIG. 2(a) depicts image capturing for a finger pad in a dark environment. FIG. 2(b) depicts features in a captured image of the finger pad in a dark environment. Assume that the user touches the display screen of the liquid crystal display with the pad of the index finger in a dark room as shown in FIG. 2(a).

The captured image 61 in FIG. 2(b) is obtained from the reflection of backlight off the image capture object (finger pad). The image 61 shows a blurred white round figure. The gradient direction for the pixels roughly matches the direction from an edge part in the captured image to near the center of an area surrounded by the edge part. (Here, the gradient direction is positive when it goes from the dark part toward the bright part.)

Next, FIG. 2(c) depicts image capturing for a finger pad in a bright environment. FIG. 2(d) depicts features in a captured image of the finger pad in a bright environment. Assume that the user touches the display screen of the liquid crystal display with the pad of the index finger in a bright room as shown in FIG. 2(c).

In this case, the captured image 62 in FIG. 2(d) is obtained from external light incident to the display screen of the liquid crystal display device (and partly obtained also from the reflection of backlight when the finger pad is in contact with the display screen). The image 62 shows a shadow of the index finger made by the finger blocking the external light and a blurred white round figure made by the reflection of backlight light off the finger pad being in contact with the display screen of the liquid crystal display device. Among these, the gradient direction in the white round part matches a similar direction to that observed in the foregoing case of the finger pad being in contact in a dark room. The shadow around the white round part is however dark, whereas the surroundings are bright due to the external light. The gradient direction for each pixel therefore matches the opposite direction to the gradient direction in the white round part.

FIG. 2(e) depicts image capturing for a pen tip in a dark environment. FIG. 2(f) depicts features in a captured image of the pen tip in a dark environment. Assume that the user touches the display screen of the liquid crystal display with a pen tip in a dark room as shown in FIG. 2(e).

In this case, the captured image 63 in FIG. 2(f) is obtained from the reflection of backlight off the image capture object (pen tip). The image 63 shows a small blurred white round figure. The gradient direction for the pixels roughly matches the direction from an edge part in the captured image to near the center of an area surrounded by the edge part.

Next, FIG. 2(g) depicts image capturing for a pen tip in a bright environment. FIG. 2(h) depicts features in a captured image of the pen tip in a bright environment. Assume that the user touches the display screen of the liquid crystal display with a pen tip in a bright room as shown in FIG. 2(g).

In this case, the captured image 64 in FIG. 2(h) is obtained from external light incident to the display screen of the liquid crystal display device (and partly obtained also from the reflection of backlight when the finger pad is in contact with the display screen). The image 64 shows a shadow of the pen made by the pen blocking the external light and a small blurred white round figure made by the reflection of backlight light off the pen tip being in contact with the display screen of the liquid crystal display device. Among these, the gradient direction in the small white round part matches a similar direction to that observed in the foregoing case of the pen tip being in contact in a dark room. The shadow around the white round part is however dark, whereas the surroundings are bright due to the external light. The gradient direction for the pixels therefore matches the opposite direction to the gradient direction in the small white round part.

These gradient directions generally match a direction either from an edge part in the captured image to near the center of an area surrounded by the edge part or radially from near the center toward the edge part, for example, for the finger surface or like soft surface which forms a round contact face upon contact with another surface and for the round-tipped pen or like surface which forms a round contact face despite its hardness. For contact faces of other shapes, the gradient directions again generally match a direction either from an edge part in the captured image to the inside of an area surrounded by the edge part or from the inside of an area surrounded by an edge part toward the outside of the area. This tendency does not change much with the condition of the image capture object, for example. The gradient direction is hence a suitable quantity for pattern matching.

Next, referring to FIG. 1, the configuration of the image processing device 1 in accordance with the present embodiment will be described in detail.

The image processing device 1 has a function of identifying a position in a captured image pointed at with an image capture object from image data for the captured image as illustrated in FIG. 1. The device 1 includes a resolution reduction section 2, a pixel-value vertical-gradient-quantity calculation section (gradient calculation means) 3a, a pixel-value horizontal-gradient-quantity calculation section (gradient calculation means) 3b, an edge extraction section (edge pixel identification means, touch/non-touch determining means) 4, a gradient direction/null direction identifying section (gradient direction identifying means) 5, a matching efficiency improving section (matching efficiency improving means) 6, a matching pixel count calculation section (correspondence degree calculation means) 7, a model pattern and comparative matching pattern storage section 8, a pattern correspondence degree calculation section (correspondence degree calculation means) 9, a score calculation section (correspondence degree calculation means, touch/non-touch determining means) 10, and a position identifying section (position identifying means) 11.

The resolution reduction section 2 reduces the resolution of image data for a captured image.

The pixel-value vertical-gradient-quantity calculation section 3a and the pixel-value horizontal-gradient-quantity calculation section 3b calculates, for each pixel in the image data, a vertical-direction gradient quantity and a horizontal-direction gradient quantity for a pixel value of a target pixel from the pixel value of the target pixel and the pixel values of adjoining pixels. Specifically, an edge extraction operator, such as the Sobel operator or the Prewitt operator, may be used.

As an example, the Sobel operator is described. The local vertical-direction gradient Sy and the horizontal-direction gradient Sx at pixel position x(i,j) of a pixel are given by a pair of equations (1) below:

Sₓ=xᵢ₊₁ⱼ₋₁−xᵢ₋₁ⱼ₋₁+2xᵢ₊₁ⱼ−2xᵢ₋₁ⱼ+xᵢ₊₁ⱼ₊₁−xᵢ₋₁ⱼ₊₁

S_{y}=xᵢ₋₁ⱼ₊₁−xᵢ₋₁ⱼ₋₁+2xᵢⱼ₊₁−2xᵢⱼ₋₁+xᵢ₊₁ⱼ₊₁−xᵢ₊₁ⱼ₋₁ (1)

where xᵢⱼ is the pixel value at pixel position x(i,j), i is the position of the pixel in the horizontal direction, j is the position of the pixel in the vertical direction, and i and j are positive integers.

Equations (1) are equivalent to applying the 3×3 Sobel operators (matrix operators Sx and Sy) in equations (2) and (3) to 3×3 pixels including the target pixel at pixel position x(i,j)

$$\begin{matrix}Math . 1 & \\ Sx = [ \begin{matrix}- 1 & 0 & 1 \\ - 2 & 0 & 2 \\ - 1 & 0 & 1\end{matrix} ] & ( 2 ) \\ Sy = [ \begin{matrix}- 1 & - 2 & - 1 \\ 0 & 0 & 0 \\ 1 & 2 & 1\end{matrix} ] & ( 3 )\end{matrix}$$

From the vertical-direction gradient Sy and the horizontal-direction gradient Sx, the gradient magnitude ABS(S) and the gradient direction ANG(S) at pixel position x(i,j) are given below. Note that throughout the following description, the vertical-direction gradient quantity and the horizontal-direction gradient quantity obtained by applying the vertical-direction gradient Sy and the horizontal-direction gradient Sx as operators to a pixel may be called respectively as the vertical-direction gradient quantity Sy and the horizontal-direction gradient quantity Sx for convenience.

ABS(S)=(Sx²+Sy²)^{1/2} (4)

ANG(S)=tan⁻¹(Sy/Sx) (5)

The edge extraction section 4 extracts (identifies) edge pixels (first edge pixels), or pixels in an edge part in the captured image, from results of calculation of the vertical-direction gradient quantity Sy and the horizontal-direction gradient quantity Sx for the pixels performed by the pixel-value vertical-gradient-quantity calculation section 3a and the pixel-value horizontal-gradient-quantity calculation section 3b.

An edge pixel is a pixel forming a part (edge) of the image data at which brightness changes abruptly. More specifically, an edge pixel is a pixel for which both the vertical-direction gradient quantity Sy and the horizontal-direction gradient quantity Sx or the gradient magnitude ABS(S) is greater than or equal to a predetermined first threshold.

The purpose of extracting the first edge pixels is to enable the gradient direction/null direction identifying section 5 to identify a gradient direction for the extracted first edge pixels and to regard and identify all the pixels that are not the first edge pixels as equally having null direction.

The important information in pattern matching is the gradient direction for the first edge pixels in the edge part.

Therefore, by regarding the gradient direction for pixels of relatively low importance as equally having null direction, the pattern matching efficiency is further improved. This scheme also reduces memory size and processing time in detecting a position in the captured image pointed at with an image capture object (discussed later), further reducing the cost for the detection of the pointing position.

Apart from the function above, the edge extraction section 4 has a function of generating an edge mask. The edge mask is binary data obtained by binarization of the image data generated by, for example, specifying a second threshold greater than the first threshold and setting the gradient magnitude ABS(S) calculated from the vertical-direction gradient quantity and the horizontal-direction gradient quantity to 1 when the gradient magnitude ABS(S) is in excess of (or greater than or equal to) the second threshold and 0 when the gradient magnitude ABS(S) is less than or equal to (or less than) the second threshold. This edge mask is referenced to identify the pixels at positions with a gradient magnitude ABS(S) of 1 as the second edge pixels.

The gradient direction/null direction identifying section 5 is adapted to identify a gradient direction for the extracted second edge pixels and to regard and identify the pixels that are not the second edge pixels as equally having null direction.

Alternatively, of the first edge pixels extracted based on the first threshold, those first edge pixels located at the positions where the edge mask value is 1 may be regarded as being valid, and those first edge pixels located at the positions where the edge mask value is 0 as being invalid so that the valid first edge pixels can be selected for pattern matching.

The gradient direction/null direction identifying section 5 identifies, for each pixel, either a gradient direction ANG(S) or null direction where both the vertical-direction gradient quantity Sy and the horizontal-direction gradient quantity Sx or the gradient magnitude ABS(S) is less than the predetermined threshold, from the vertical-direction gradient quantity Sy and the horizontal-direction gradient quantity Sx calculated by the pixel-value vertical-gradient-quantity calculation section 3a and the pixel-value horizontal-gradient-quantity calculation section 3.

Having null direction is defined here as “being less than a predetermined threshold.” Alternatively, it may be defined as “being less than or equal to a predetermined threshold.”

The advance labeling as “having null direction” limits occurrences of numerous unwanted gradient directions which would otherwise be caused by noise and other factors. The advance labeling also leads to reducing matching targets to gradient directions near the edge, allowing for more efficient matching.

Preferably, the gradient direction/null direction identifying section 5 identifies a gradient direction for the edge pixels identified by the edge extraction section 4 and identifies the pixels that are not the edge pixels by regarding those pixels as having null direction. It may be said that the important information in pattern matching is the gradient direction for the edge pixels in the edge part.

Therefore, by regarding the gradient direction for pixels of relatively low importance as equally having null direction in pattern matching, the pattern matching efficiency is further improved.

The gradient direction ANG(S) is a continuous quantity varying from 0 rad to 2π rad. In the present embodiment, the gradient direction ANG(S) is quantized into 8 directions which will be used as gradient directions, or the characteristic quantity (hereinafter, may be referred to as the “characteristic quantity”), for use in pattern matching. The gradient direction ANG(S) may be quantized into 16 directions for higher precision pattern matching. A specific process for quantization of direction will be detailed later. By quantization of direction, it is meant that the gradient direction ANG(S) within a predetermined range is treated by equally regarding it as a particular gradient direction.

The matching efficiency improving section 6 allows for more efficient matching of a matching region which is a region, around the target pixel, containing a predetermined number of pixels with a predetermined model pattern (hereinafter, may be referred to as the “pattern matching”).

The matching pixel count calculation section 7, for example, matches the matching region with the model pattern to calculate the number of pixels for which the gradient direction contained in the matching region matches the gradient direction contained in the model pattern (hereinafter, the “matching pixel count”).

The model pattern and comparative matching pattern storage section 8 stores the model patterns and the comparative matching patterns predetermined by analyzing matching patterns between the gradient direction for each pixel in the matching region and the gradient direction for each pixel in the model pattern. The model pattern and comparative matching pattern storage section 8 may be, for example, a tape, such as a magnetic tape or a cassette tape; a magnetic disk, such as a floppy® disk or a hard disk, or an optical disc, such as a CD-ROM/MO/MD/DVD/CD-R; a card, such as an IC card (memory card) or an optical card; or a semiconductor memory, such as a mask ROM/EPROM/EEPROM/flash ROM.

The pattern correspondence degree calculation section 9 calculates a pattern correspondence degree which is a degree of similarity of the matching pattern between the gradient direction for each pixel in the matching region and the gradient direction for each pixel in the model pattern to the predetermined comparative matching pattern.

The score calculation section 10 calculates an correspondence degree which is a degree of matching of the matching region with the model pattern from the matching pixel count calculated by the matching pixel count calculation section 7 and the pattern correspondence degree calculated by the pattern correspondence degree calculation section 9. The score calculation section 10 may be adapted to use either one of the matching pixel count calculated by the matching pixel count calculation section 7 and the pattern correspondence degree calculated by the pattern correspondence degree calculation section 9.

The score calculation section 10 may be adapted to calculate the correspondence degree if the number of types of corresponding gradient directions in the matching region is greater than or equal to a preset value.

The gradient direction has the general tendency described above. The tendency does not change much with the condition of the image capture object, for example. Therefore, for example, if the number of types of gradient directions is 8, the number of types of matching gradient directions in pattern matching should be close to 8. Hence, if the correspondence degree is calculated when the number of types of corresponding gradient directions in the matching region is greater than or equal to a preset value, the detection of the pointing position requires smaller memory and less processing time. That in turn further reduces the cost for the detection of the pointing position.

The light entering the built-in image capture sensors in the liquid crystal display device may be a mixture of reflection of the backlight and external light coming from the outside.

When this is the case, it is difficult to separate effects of the reflection of the backlight and effects of the external light coming from the outside from the captured image.

In backlight reflection base, the image obtained from the reflection of the backlight off the image capture object shows a blurred white round figure, for example, for a finger pad. Accordingly, in this case, the first threshold is set to a relatively low value so that the edge extraction section 4 can identify the first edge pixels.

On the other hand, in shadow base, the captured image is blurred (low contrast) if the image capture object (for example, the finger pad) is positioned off the panel surface (non-touch) and sharp (high contrast) if the image capture object is in contact with the panel surface. Therefore, in shadow base, the second threshold is set to a relatively high value so that the edge extraction section 4 can identify the second edge pixels in accordance with a more stringent edge determining standard than for the first threshold.

Pattern matching is thus carried out between the image data in which the first edge pixels are identified and a first model pattern predetermined in backlight reflection base and also between the image data in which the second edge pixels are identified and a second model pattern predetermined in shadow base, to obtain the first number of pixels and the second number of pixels. In this case, the score calculation section 10 can use, for example, the sum of the first number of pixels and the second number of pixels as the correspondence degree.

The score calculation section 10, as discussed above, calculates the correspondence degree from the first number of pixels for which the gradient directions of the first edge pixels contained in the matching region match the gradient directions contained in the predetermined first model pattern and the second number of pixels for which the gradient directions of the second edge pixels contained in the matching region match the gradient directions contained in the predetermined second model pattern.

Therefore, this single configuration can carry out processes compatible with both backlight reflection base and shadow base without switching the processes between backlight reflection base and shadow base. The embodiment hence provides an image processing device capable of identifying the position pointed at with the image capture object both under good and poor illumination.

The position identifying section 11 identifies the position in the captured image pointed at with the image capture object from the position of a pixel for which the correspondence degree calculated by the score calculation section 10 is a maximum (hereinafter, “peak pixel”). The section 11 includes a peak search section (peak pixel identifying means, position identifying means) 12, a coordinate calculation determining section (coordinate calculation determining means, position identifying means) 13, and a coordinate calculation section (coordinate calculation means, position identifying means) 14.

The peak search section 12 searches a search area containing a predetermined number of pixels around the target pixel (hereinafter, may be referred to as “first area”) for a peak pixel which is a pixel for which the correspondence degree calculated by the score calculation section 10 is a maximum.

The coordinate calculation determining section 13 causes the coordinate calculation section 14 to calculate the position in the captured image pointed at with the image capture object if the section 13 has determined that the peak pixel found by the peak search section 12 is present in a sub-area which contains a predetermined number of pixels that is less than the number of pixels in the search area and which is also completely enclosed in the search area (hereinafter, may be referred to as “second area”).

The coordinate calculation section 14 calculates the position in the captured image pointed at with the image capture object by using the correspondence degree for each pixel in a peak pixel region which is a region containing a predetermined number of pixels centered around the peak pixel found by the peak search section 12.

In the configuration discussed above, the pixel-value vertical-gradient-quantity calculation section 3a and the pixel-value horizontal-gradient-quantity calculation section 3b calculate, for each pixel in the image data, the vertical-direction gradient quantity Sy and the horizontal-direction gradient quantity Sx from the pixel value for that pixel and the pixel values of adjoining pixels to the pixel.

In addition, from the vertical-direction gradient quantity Sy and the horizontal-direction gradient quantity Sx calculated by the pixel-value vertical-gradient-quantity calculation section 3a and the pixel-value horizontal-gradient-quantity calculation section 3b, the gradient direction/null direction identifying section 5 identifies, for each pixel, either a gradient direction (direction quantized according to ANG(S) value; similar description will be omitted in the following) or null direction where both the vertical-direction gradient quantity Sy and the horizontal-direction gradient quantity Sx or the gradient magnitude ABS(S) calculated from the vertical-direction gradient quantity Sy and the horizontal-direction gradient quantity Sx is less than the predetermined threshold.

The vertical-direction gradient quantity Sy, the horizontal-direction gradient quantity Sx, the gradient direction, the gradient magnitude ABS(S), etc. for the pixel value are quantities obtained from a single-frame captured image. In addition, these quantities are obtainable irrespective of detection of a touch/non-touch of the captured image with the image capture object.

Next, the score calculation section 10 matches the matching region with the model pattern to calculate the correspondence degree which is a degree of matching of the matching region with the model pattern from the number of pixels (matching pixel count) for which the gradient direction contained in the matching region matches the gradient direction contained in the model pattern.

A scalar quantity, such as a pixel value (density level), could possibly be used as the quantity used in the matching of a matching region with a predetermined model pattern (pattern matching). It is however difficult to set up model patterns in advance because the scalar quantity, even when quantized (values within a predetermined range are treated by equally regarding them as a particular constant), is ever variable depending on, for example, the condition of the image capture object.

Meanwhile, the gradient of the pixel value is a vector quantity with both magnitude (gradient magnitude ABS(S)) and direction (gradient direction ANG(S)). Especially, the gradient direction (orientation), for example, when quantized into 8 directions, enables discretization of any potential states for the pixels with as few as 8 states (or 9 if null direction is included), which is an extremely small number. Furthermore, the discretized states render different directions readily distinguishable.

The gradient direction has the general tendency described above. The tendency does not change much with the condition of the image capture object, for example. The gradient direction is hence a suitable quantity for pattern matching.

Pattern matching is therefore possible by using image data for only one frame, irrespective of detection of a touch/non-touch of the captured image with the image capture object. Pattern matching is thus possible with small memory and short processing time.

Next, the position identifying section 11 identifies the position in the captured image pointed at with the image capture object from the position of the target pixel (peak pixel) for which the correspondence degree calculated by the score calculation section 10 is a maximum.

The gradient direction has the general tendency described above. Therefore, the neighborhood of the maximum of the correspondence degree would be regarded as indicating the neighborhood of the position in the captured image pointed at with the image capture object. Therefore, taking the tendency of the gradient direction into consideration, by setting up model patterns in advance for each image capture object (for example, for each illumination environment (bright or dark) for an image capture object for which the gradient direction is distributed like a doughnut in the image data or for each size of the image capture object (for example, the finger pad is large, whereas the pen tip small)), the position in the captured image pointed at with the image capture object can be identified from the position of the peak pixel obtained in the pattern matching.

Hence, the image processing device 1, as an example, is provided which, irrespective of detection of a touch/non-touch of the captured image with the image capture object, can detect the position in the captured image pointed at with the image capture object with small memory and short processing time by using image data for only one frame.
2. Overview of Operation of Image Processing Device

### (Electronic Apparatus)

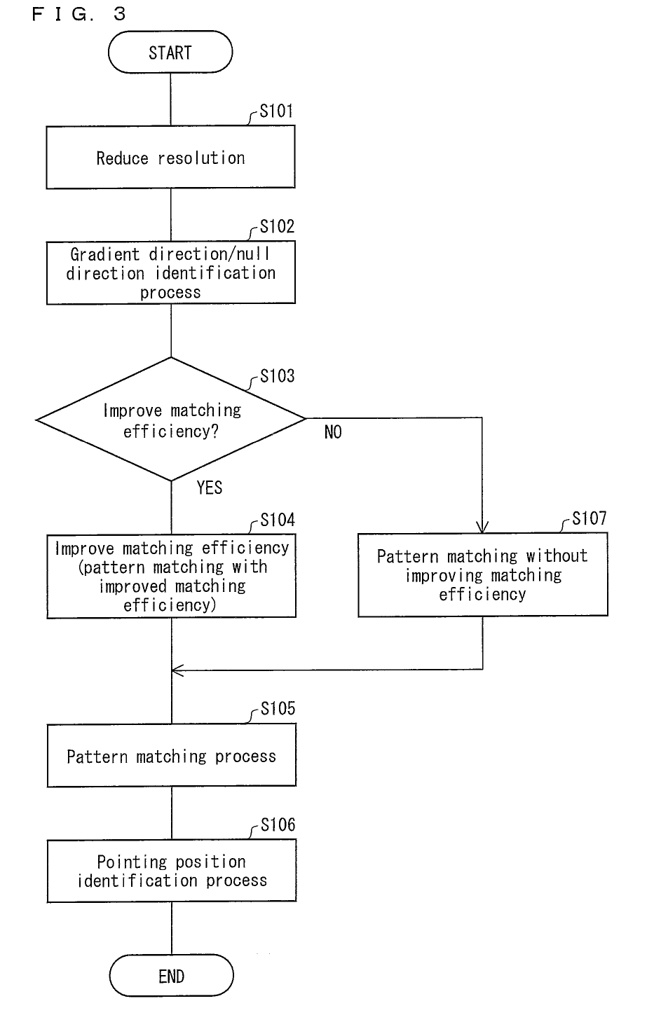

Next, referring to FIGS. 1 and 3, an overview is given of operation of the image processing device 1 (electronic apparatus 20) which is an embodiment of the present invention.

The configuration is the same as in 1. Configuration of Image Processing Device (Electronic Apparatus) except those points raised in 2. Overview of Operation of Image Processing Device (Electronic Apparatus). For convenience in description, members of the present embodiment that have the same function as members depicted in the drawings referred to in 1. Configuration of Image Processing Device (Electronic Apparatus) are indicated by the same reference numerals and description thereof is omitted. The following description is, where necessary, divided into distinct sections, under which these special notes will not be repeated.

FIG. 3 is a flow chart for the entire operation of the image processing device 1. In step S101 (hereinafter, “S101”), the resolution reduction section 2 shown in FIG. 1 reduces the resolution of the image data. The operation then continues at S102. For example, 320×240 pixel image data is bilinear downscaled to 160×120 pixels (resolution reduction ratio=½) or 80×60 pixels (resolution reduction ratio=¼). Bilinear downscaling is defined as, for example, averaging pixel values for 2×2 pixels and substituting the 1×1 pixels data having the average value for the 2×2 pixel data to achieve an overall ×¼ data compression.

The resolution should be reduced as much as possible for high speed processing. To obtain necessary edge and other information, however, a preferred resolution reduction limit for 320×240 pixel (150 dpi) image data, as an example, is 80×60 pixels (resolution reduction ratio=¼). In addition, for high precision processing, the resolution is better not reduced at all, or if reduced to any extent, should not go below 160×120 pixels (resolution reduction ratio=½).

This image data resolution reduction allows for reduction in processing cost, memory size, and processing time in the pattern matching.

In S102, the pixel-value vertical-gradient-quantity calculation section 3a and the pixel-value horizontal-gradient-quantity calculation section 3b calculate the vertical-direction gradient quantity Sy and the horizontal-direction gradient quantity Sx for each pixel in the image data. Then, after the gradient direction/null direction identifying section 5 completes up to either the identifying of a gradient direction or the labeling as having null direction for each pixel (gradient direction/null direction identification process), the operation proceeds to S103.

In S103, for the case the matching efficiency improving section 6 matches the matching region with the model pattern, it is selected whether or not the matching efficiency for the matching region and the model pattern (matching efficiency improvement) is to be improved. If the matching efficiency improvement is to be carried out (Yes), the operation proceeds to S104 where the matching efficiency improving section 6 carries out the matching efficiency improvement before further proceeding to S105. If the matching efficiency improvement is not to be carried out (No), the operation continues at S107 where the matching efficiency improving section 6 performs no process at all on the data (image data, or if the resolution reduction section 2 has performed the resolution reduction, post-resolution-reduction image data), thereby leaving the data unchanged, before the operation further proceeding to S105.

The matching pixel count calculation section 7, in S105, matches the matching region with the model pattern to calculate the matching pixel count, and the pattern correspondence degree calculation section 9 calculates the pattern correspondence degree. Then, after the score calculation section 10 completes up to the calculating of the correspondence degree from the matching pixel count calculated by the matching pixel count calculation section 7 and the pattern correspondence degree calculated by the pattern correspondence degree calculation section 9 (pattern matching process), the operation proceeds to S106.

In S106, the position identifying section 11 identifies the position in the captured image pointed at with the image capture object from the position of a pixel for which the correspondence degree calculated by the score calculation section 10 is a maximum (hereinafter, “peak pixel”) (pointing position identification process), thereby ending the operation.

That is an overview of the entire operation of the image processing device 1. The following is a description of the operation of the image processing device 1 in the gradient direction/null direction identification process, the matching efficiency improvement, the pattern matching process, and the pointing position identification process.
3. Gradient Direction/Null Direction Identification Process

First, referring to FIGS. 1, 4, 5(a), and 5(b), the operation of the image processing device 1 in the gradient direction/null direction identification process will be described.

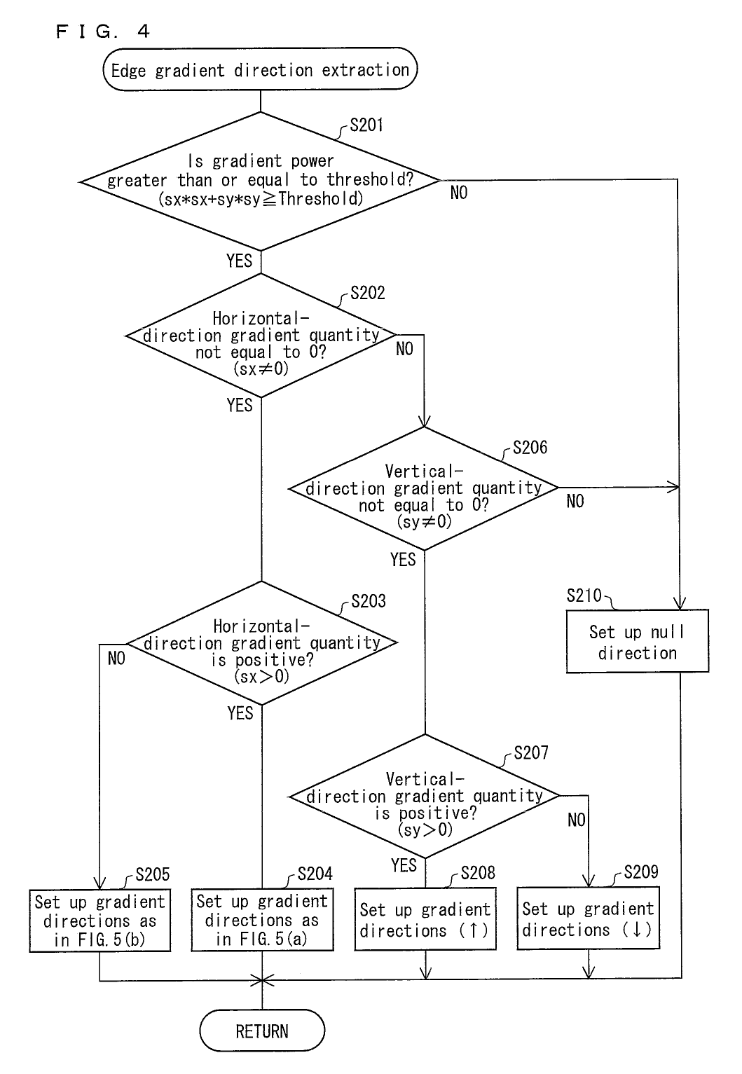

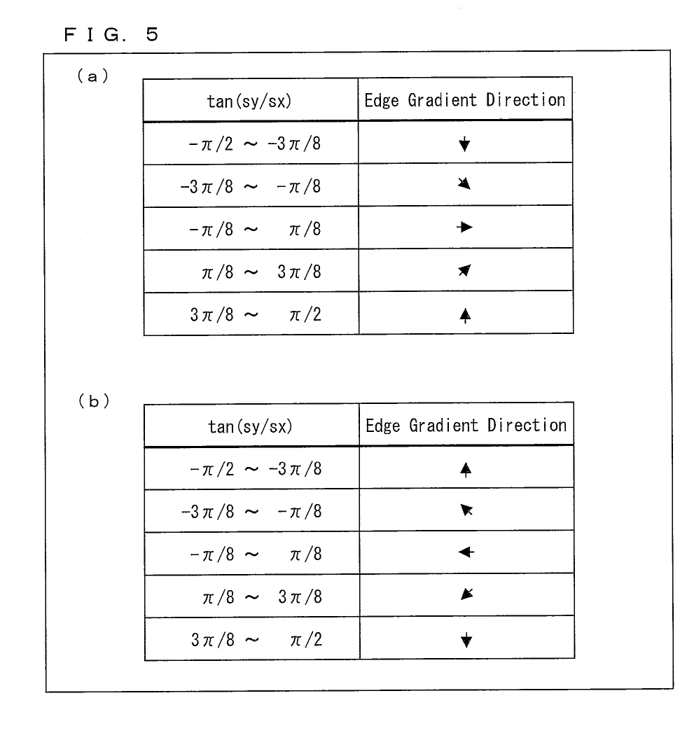

FIG. 4 is a flow chart for a part of the operation of the image processing device 1, or the gradient direction/null direction identification process. FIG. 5(a) shows an exemplary table referenced in the gradient direction/null direction identification process. FIG. 5(b) shows another exemplary table referenced in the gradient direction/null direction identification process.

In the flow chart in FIG. 4, the operation starts after the pixel-value vertical-gradient-quantity calculation section 3a and the pixel-value horizontal-gradient-quantity calculation section 3b calculate the vertical-direction gradient quantity Sy and the horizontal-direction gradient quantity Sx respectively.

In S201, the edge extraction section 4 determines whether or not the gradient magnitude ABS(S) (“gradient power” in FIG. 4) at each pixel is greater than or equal to a predetermined threshold (first threshold/second threshold). If ABS(S)≧Threshold (Yes), the operation proceeds to S202; if ABS(S)<Threshold, the operation proceeds to S210. It is presumed in the present embodiment that ABS(S)=Sx*Sx+Sy*Sy. This quantity, in strict sense, is not identical to the gradient magnitude in equation (4) above. This definition of the gradient magnitude, however, poses no problems in practice.

If the operation has proceeded to S210, the gradient direction/null direction identifying section 5 labels (identifies) a target pixel (pixel that is not the first edge pixels) as having null direction and moves to a next pixel before the operation returns to S201.

In S202, the gradient direction/null direction identifying section 5 determines whether or not the horizontal-direction gradient quantity Sx is 0. If Sx≠0, the operation returns to S203 (Yes); if Sx=0, the operation returns to S206 (No).

The gradient direction/null direction identifying section 5, in S203, determines whether or not the horizontal-direction gradient quantity Sx is positive. If Sx>0, the operation returns to S204 (Yes). Then, in accordance with the table in FIG. 5(a), the gradient direction/null direction identifying section 5 sets up gradient directions quantized according to the gradient direction ANG(S) for the pixel (first edge pixel/second edge pixel). In contrast, if Sx<0, the operation returns to S205. Then, in accordance with the table in FIG. 5(b), the gradient direction/null direction identifying section sets up gradient directions quantized according to the gradient direction ANG(S) for the pixel (first edge pixel/second edge pixel).

Next, in S206, the gradient direction/null direction identifying section 5 determines whether or not the vertical-direction gradient quantity Sy is 0. If Sy≠0, the operation proceeds to S207 (Yes); if Sy=0, the operation proceeds to S210 (No) where the pixel (pixel that is neither the first edge pixels nor the second edge pixels) is labelled as having null direction. The process then moves to a next pixel before the operation returns to S201.

The gradient direction/null direction identifying section 5, in S207, determines whether or not the vertical-direction gradient quantity Sy is positive. If Sy>0, the operation continues at S208 (Yes) where the pixel (first edge pixel/second edge pixel) is set to the upward gradient direction before the operation returns to S201. In contrast, if Sy<0, the operation continues at S209 (No) where the pixel (first edge pixel/second edge pixel) is set to the downward gradient direction. The process then moves to a next pixel before the operation returns to S201. These steps are repeated until every pixel is either assigned a gradient direction or labelled as having null direction.

The important information in pattern matching is the gradient direction for the edge pixels (first edge pixels/second edge pixels) in the edge part.

Therefore, by regarding the gradient direction (pixel that is neither the first edge pixels nor the second edge pixels) for pixels of relatively low importance as equally having null direction in the operation, the pattern matching efficiency is further improved. The scheme also enables the detection of the position in the captured image pointed at with the image capture object with small memory and short processing time, further reducing the cost for the detection of the pointing position.
4. Matching Efficiency Improvement

Next, referring to FIGS. 1 and 6 to 9, the matching efficiency improvement in the image processing device 1 will be described.

The matching efficiency improving section 6 shown in FIG. 1 divides the matching region into divisional regions containing equal numbers of pixels and replaces, for each divisional region, the gradient direction/null direction information for each pixel contained in that divisional region with the gradient direction/null direction information contained in the divisional region, to improve the matching efficiency for the matching region and the model pattern.

The score calculation section 10 matches the matching region with the model pattern with the efficiency as improved by the matching efficiency improving section 6 to calculate the number of matches of the gradient direction contained in each divisional region in the matching region with the gradient direction contained in the model pattern as the correspondence degree.

The gradient direction has the general tendency described above. The tendency does not change much with the condition of the image capture object, for example. Therefore, if the number of pixels in each divisional region is not set to a very large value, the positions of the pixels for the gradient direction in the divisional regions are not very important information in the pattern matching using the gradient direction.

Accordingly, by replacing, for each divisional region, the gradient direction/null direction information for each pixel contained in that divisional region with the gradient direction/null direction information contained in the divisional region, the matching efficiency improvement is accomplished, while maintaining precision in the pattern matching. In addition, the efficiency improvement results in reduction in the cost of the detection of the position in the captured image pointed at with the image capture object.

Hence, the image processing device 1, as an example, is provided which improves the matching efficiency and reduces the cost in the detecting of the position in the captured image pointed at with the image capture object, while maintaining precision in the pattern matching.

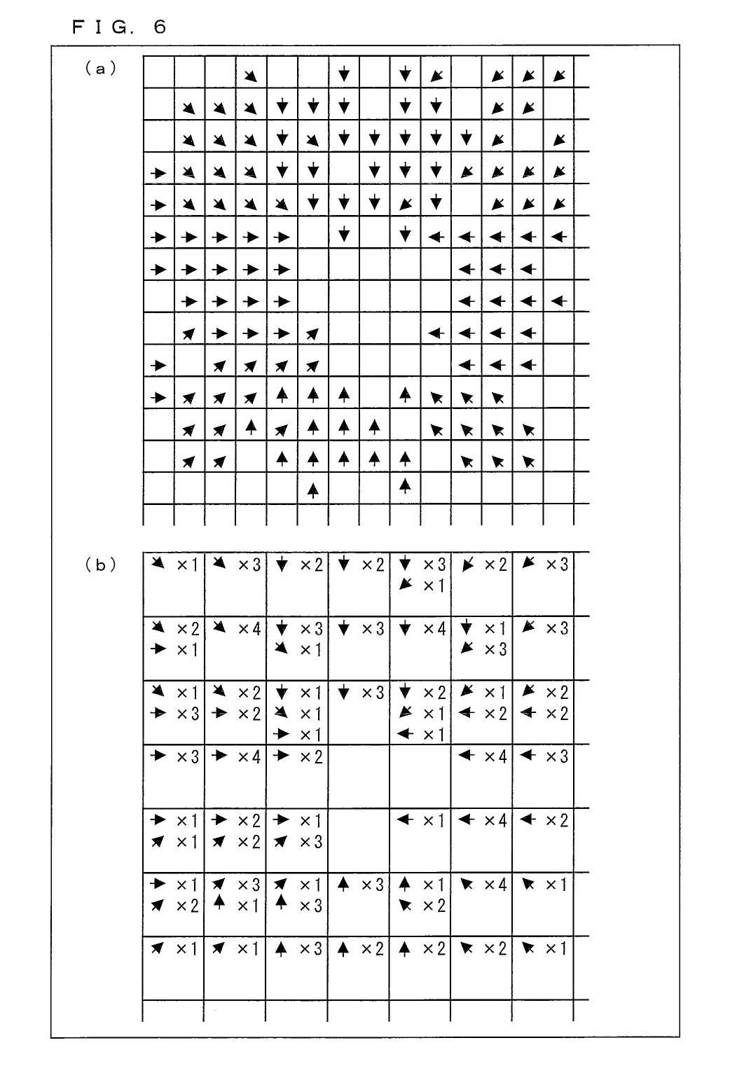

Referring to FIGS. 6(a) to 6(b), a concrete example of the matching efficiency improvement in the image processing device 1 will be described.

As shown in FIG. 6(a), the distribution of the gradient direction for the pixels in the image data in a dark environment is characterized by the presence of a substantially round pixel region at the center in which the pixel values have null direction and the presence, around that pixel region, of large numbers of pixels for which the gradient direction points to the null direction region.

FIG. 6(b) depicts the same image data as shown in FIG. 6(a), but after matching efficiency improvement.

As shown in FIG. 6(a), a 14×14-pixel region (matching region) is matched with a model pattern (examples of the model pattern will be described later in detail) with improved efficiency by dividing the 14×14-pixel region into 2×2-pixel regions (divisional regions) and replacing, for each 2×2-pixel region, the gradient direction/null direction information for each pixel contained in that 2×2-pixel region with the gradient direction/null direction information contained in the 2×2-pixel region.

For example, in one of the 2×2-pixel regions obtained by dividing the 14×14-pixel region shown in FIG. 6(a) that is in the second row, first column, the upper left pixel has null direction, the upper right pixel has a gradient direction pointing to the lower right, the lower left pixel has a gradient direction pointing to the right, and the lower left pixel has a gradient direction pointing to the lower right. The gradient directions in this 2×2-pixel region with the information on the individual positions being omitted are shown in the block located in the second row, first column of FIG. 6(b) (hereinafter, may be referred to as the “pixels” for convenience). The other blocks are likewise generated. As a result, the 14×14-pixel region shown in FIG. 6(a) are divided into a total of 7×7=49 2×2-pixel regions.

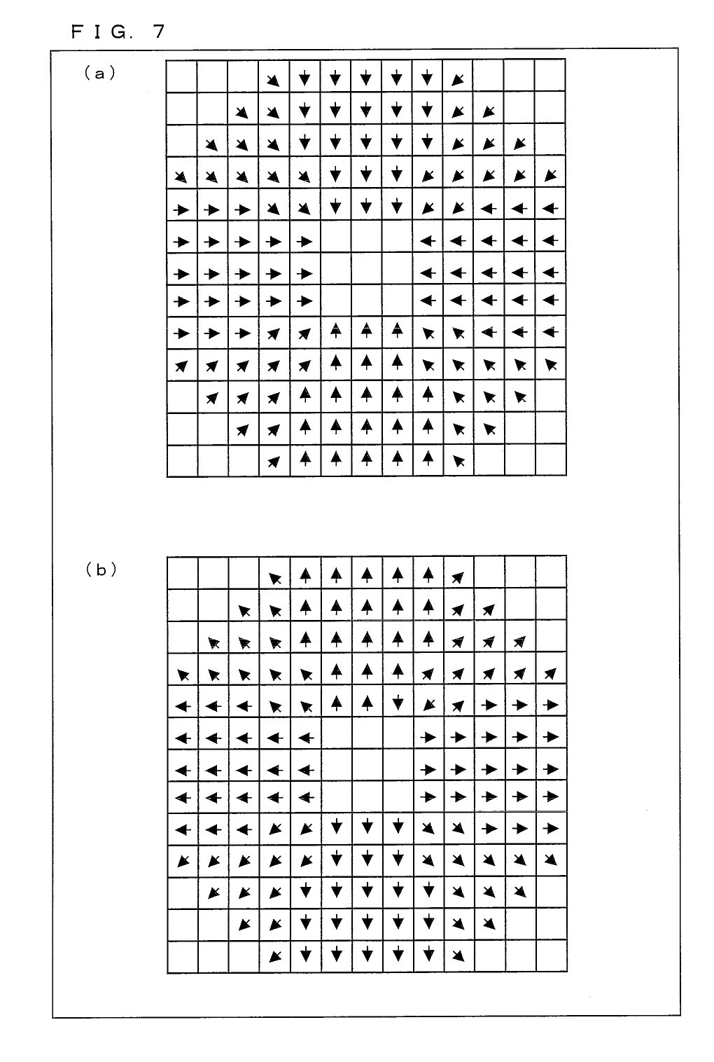

Next, referring to FIGS. 7 to 9, concrete examples of the model pattern with which the matching region is matched will be described.

FIG. 7(a) depicts an exemplary model pattern prior to matching efficiency improvement in a dark environment. The model pattern in FIG. 7(a) is prepared for pattern matching with the 14×14-pixel region shown in FIG. 6(a) and for a finger pad as the image capture object.

The model pattern in FIG. 7(a) contains 13×13 pixels; the total pixel count differs from that contained in the 14×14-pixel region shown in FIG. 6(a). As can be appreciated in this example, however, the matching region and the model pattern do not necessarily contain the same number of pixels.

The pixels are arranged in an odd number of rows by an odd number of columns (13×13) so that there is one central pixel. The central pixel is placed over a target pixel in the image data and shifted by one pixel at a time to implement the pattern matching.

In this case, since the matching is carried out for each pixel, the matching needs to be carried out on 13×13=169 pixels (the matching pixel count needs to be calculated 169 time).

Meanwhile, FIG. 7(b) depicts an exemplary model pattern prior to matching efficiency improvement in a bright environment. A comparison with the model pattern in FIG. 7(a) shows that the pixels has opposite gradient directions. FIG. 7(a) depicts image data obtained by primarily capturing the reflection of light emitted by the backlight, indicating the image growing brighter toward the center. In contrast, FIG. 7(b) depicts image data obtained by primarily capturing external light, indicating the image growing brighter toward the edge part in the image.

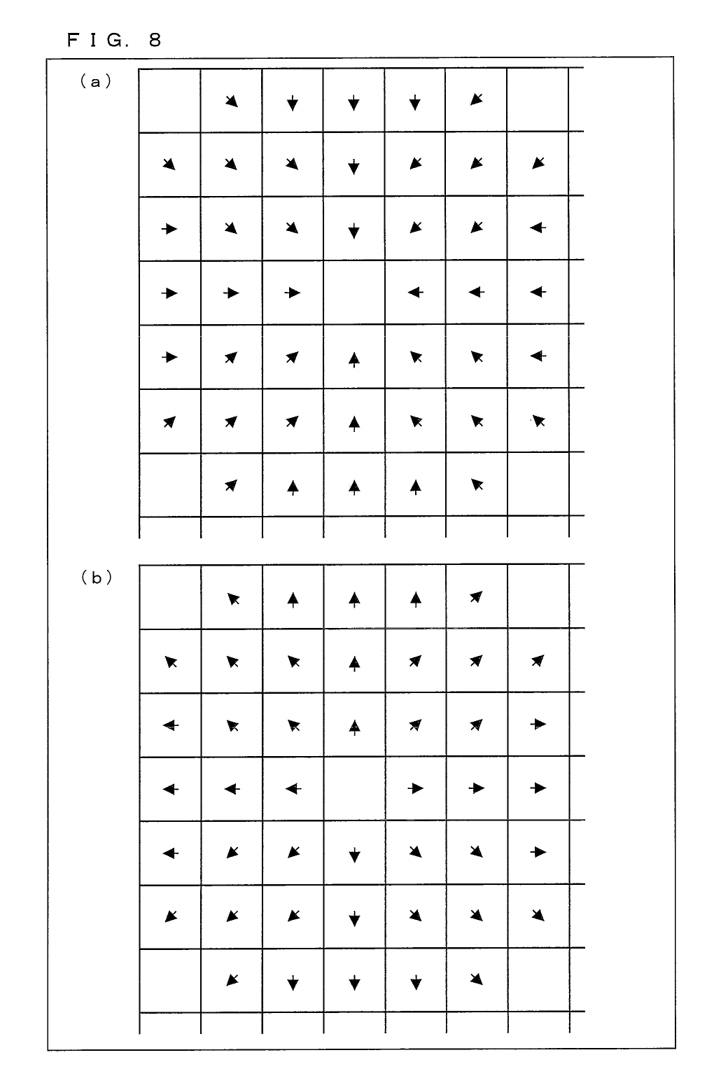

Next, FIG. 8(a) depicts an exemplary model pattern subsequent to matching efficiency improvement in a dark environment. The model pattern in FIG. 8(a) prepared for pattern matching with a matching region subsequent to the matching efficiency improvement shown in FIG. 6(b). As can be appreciated in this example, the matching region and the model pattern do not necessarily have the same data format. This example simplifies the model pattern by treating a 2×2-pixel region as a single pixel (with only one gradient direction), in order to further improve the matching efficiency.

FIG. 8(b) depicts an exemplary model pattern subsequent to matching efficiency improvement in a bright environment. FIG. 8(a) depicts image data obtained by primarily capturing the reflection of light emitted by the backlight, indicating the image growing brighter toward the center. In contrast, FIG. 8(b) depicts image data obtained by primarily capturing external light, indicating the image growing brighter toward the edge part in the image.

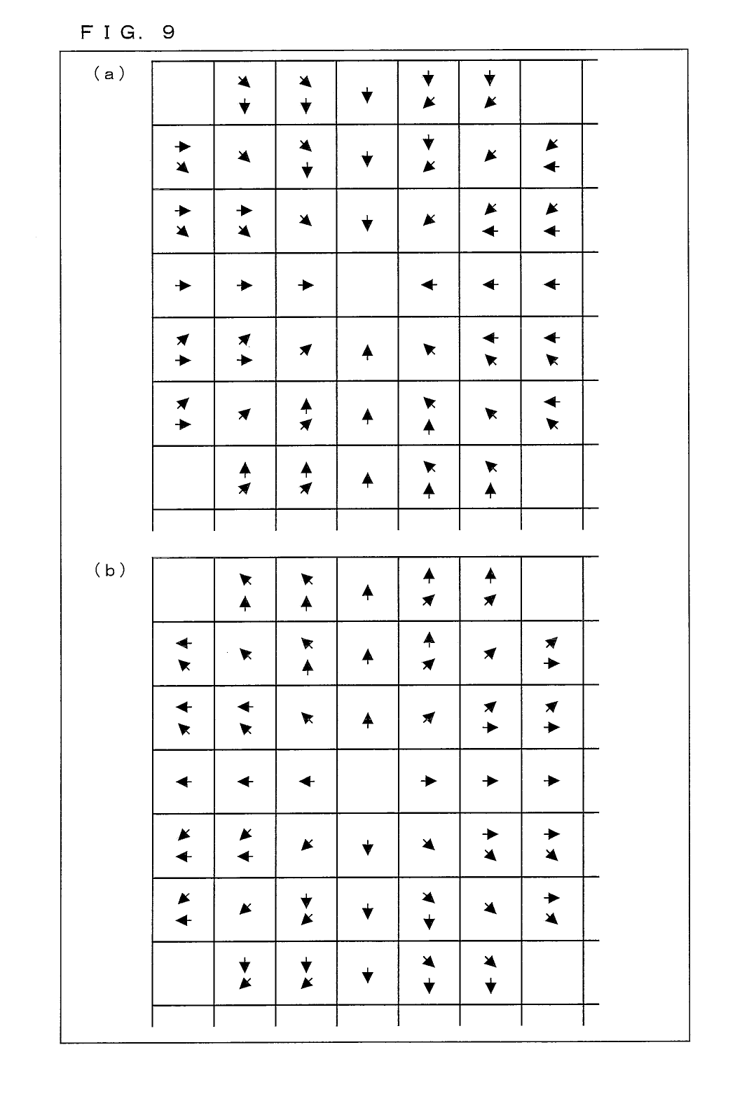

FIG. 9(a) depicts another exemplary model pattern subsequent to matching efficiency improvement in a dark environment. This model pattern is similar to the model pattern in FIG. 8(a) in that each region contains 2×2 pixels, but differs in that in the former, each region may be represented by two gradient directions (or labelled as having null direction). Carefully devising such a model pattern adds to the matching precision while pushing for further improved matching efficiency.

FIG. 9(b) depicts another exemplary model pattern subsequent to matching efficiency improvement in a bright environment. FIG. 9(a) depicts image data obtained by primarily capturing the reflection of light emitted by the backlight, indicating the image growing brighter toward the center. In contrast, FIG. 9(b) depicts image data obtained by primarily capturing external light, indicating the image growing brighter toward the edge part in the image.
5. Pattern Matching Process

Now, referring to FIGS. 1 and 10 to 17, the pattern matching process in the image processing device 1 will be described.

Referring to FIG. 1, variations of the pattern matching are summed up first. They can be divided into two groups in terms of the relationship with the edge extraction section 4, as explained earlier. One of the groups sets up a first threshold and treats values less than or equal to (or less than) the first threshold as equally having null direction. The other specifies a second threshold greater than the first threshold, devises an edge mask, and selects valid edge pixels with the edge mask to implement pattern matching.

Next, in terms of the relationship with the matching efficiency improving section 6, the variations can be divided into those implemented on image data prior to matching efficiency improvement and those implemented on image data subsequent to matching efficiency improvement.

In terms of the relationship with the score calculation section 10, the variations can be divided into those calculating the score (correspondence degree) from the matching pixel count calculated by the matching pixel count calculation section 7 and those calculating the score (correspondence degree) from the pattern correspondence degree calculated by the pattern correspondence degree calculation section 9.

As described in the foregoing, the pattern matching has many variations. Any of the variations may be carried out either singly or in combination to calculate the score.

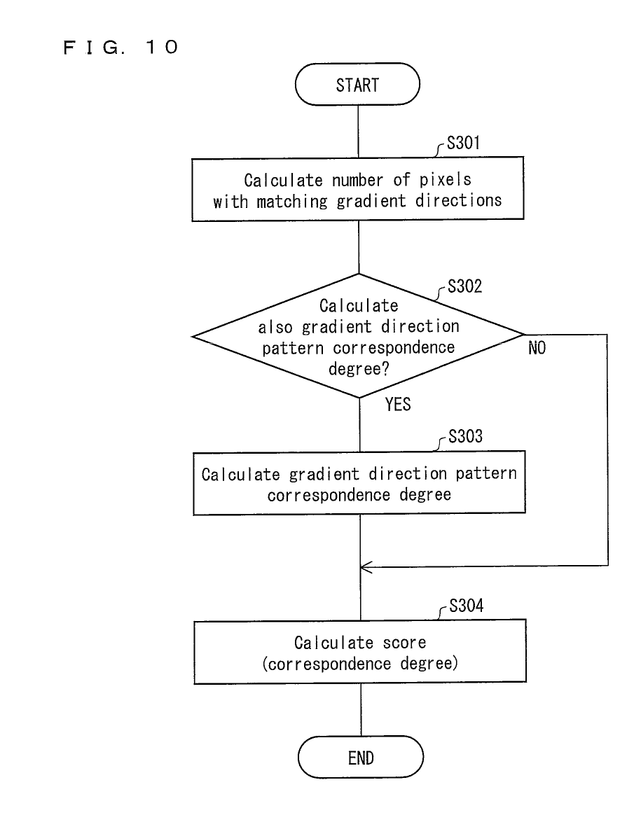

FIG. 10 is a flow chart for a part of the operation of the image processing device 1 shown in FIG. 1, or the pattern matching process.

In S301, the matching pixel count calculation section 7 matches the matching region with the model pattern to calculate the number of pixels (matching pixel count) for which the gradient direction contained in the matching region matches the gradient direction contained in the model pattern. The operation then proceeds to S302.

In S302, the matching efficiency improving section 6 (the gradient direction/null direction identifying section 5 if no matching efficiency improving section 6 is included) determines whether to calculate also a pattern correspondence degree for the gradient direction. If it is determined to calculate the pattern correspondence degree, the pattern correspondence degree calculation section 9 is notified before proceeding to S303 (Yes). On the other hand, If it is determined not to calculate the pattern correspondence degree, the score calculation section 10 is notified before proceeding to S304.

The description here assumes that the matching pixel count is always calculated. This is, however, not intended to be limiting the invention. A configuration may be employed where the pattern correspondence degree is only calculated.

The pattern correspondence degree is a quantity indicative of a similarity of the matching pattern between the gradient direction for each pixel in the matching region and the gradient direction for each pixel in the model pattern to the predetermined comparative matching pattern stored in the model pattern and comparative matching pattern storage section 8.

In S303, the pattern correspondence degree calculation section 9 is notified by either the gradient direction/null direction identifying section 5 or the matching efficiency improving section 6 of the determination to calculate the pattern correspondence degree and calculates the pattern correspondence degree, before the operation proceeds to S304.

In S304, the pattern correspondence degree calculation section 9, if not having calculated the pattern correspondence degree, calculates the matching pixel count calculated by the matching pixel count calculation section 7 as the correspondence degree which is a degree of matching of the matching region with the model pattern. On the other hand, the pattern correspondence degree calculation section 9, if having calculated the pattern correspondence degree, calculates a combined quantity of the matching pixel count calculated by the matching pixel count calculation section 7 and the pattern correspondence degree calculated by the pattern correspondence degree calculation section 9 as the correspondence degree which is a degree of matching of the matching region with the model pattern.

The gradient directions generally match a direction either from an edge part in the captured image to near the center of an area surrounded by the edge part or radially from near the center toward the edge part, for example, for the finger surface or like soft surface which forms a round contact face upon contact with another surface and for the round-tipped pen or like surface which forms a round contact face despite its hardness. For contact faces of other shapes, the gradient directions again generally match a direction either from an edge part in the captured image to the inside of an area surrounded by the edge part or from the inside of an area surrounded by an edge part toward the outside of the area.

When the image capture object does not touch on the captured image, for example, when the image capture object is a finger pad, edges may in some cases result from a large blurry shadow of those fingers which are not in contact. In addition, for example, when the input device (photo sensor) or the sensing circuit has a defect, the defect may cause a band or line of noise with accompanying edges.

If these pattern-matching-disrupting edges (hereinafter, “unnecessary edges”) have occurred, the matching pixel count may be increased locally (only in one or two directions) even when the number of pixels in the model pattern is increased. Therefore, when such an unnecessary edge is present, the matching pixel count alone would be insufficient to achieve correct recognition and suitable pattern matching.

Accordingly, for example, when the finger or the pen has come in contact, if the matching pixel count and the correspondence pattern (for example, the number of types of gradient directions) are used together based on an assumption that at least 6 or more types of gradient directions, if not all the 8 directions (which would be ideal), should appear, the cases where the correspondence degree is increased due to the local increases in the matching pixel count (only in one or two directions) can be excluded.

Therefore, robustness to noise and deformation in image input would be improved by using both the matching pixel count and the pattern correspondence degree in the pattern matching.

Hence, the image processing device 1, as an example, is provided which, irrespective of detection of a touch/non-touch of the captured image with the image capture object, can detect the position in the captured image pointed at with the image capture object with small memory and short processing time by performing the pattern matching using image data for only one frame and which can also improve the robustness to noise in image input and deformation of the captured image in the pattern matching.

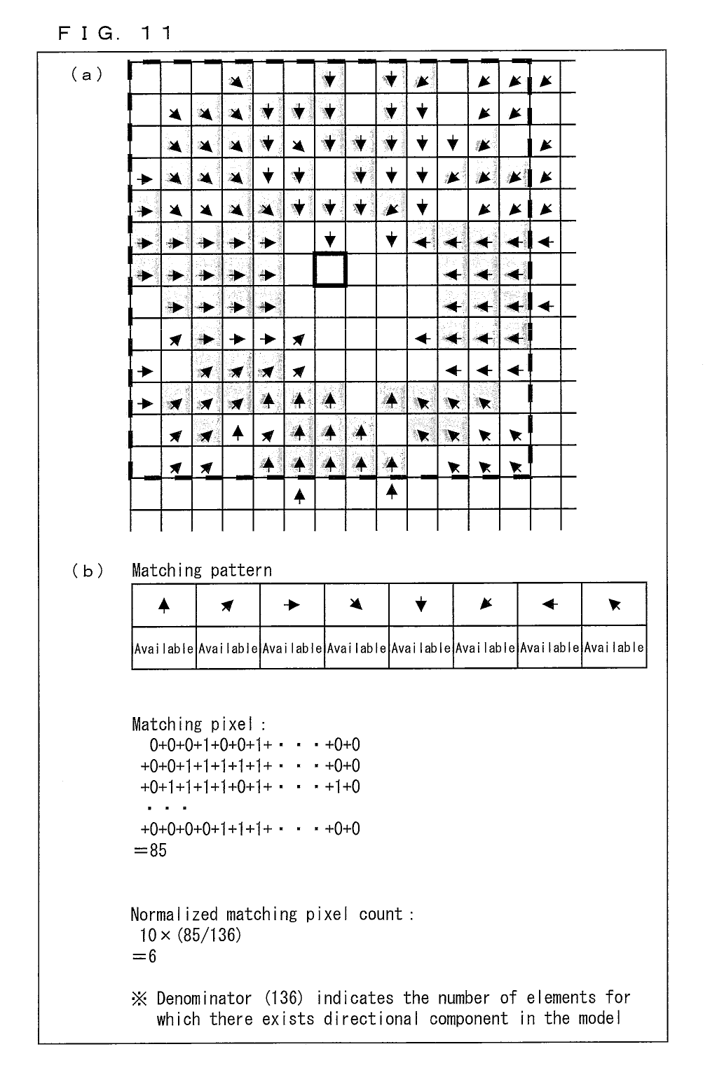

Next, referring to FIGS. 11 to 13, a specific score (correspondence degree) calculation method for the score calculation section 10 in the pattern matching process will be described.

FIG. 11(a) depicts pattern matching between a matching region and a model pattern in a dark environment prior to matching efficiency improvement. FIG. 11(b) depicts an exemplary correspondence degree calculation method for the pattern matching.

FIG. 11(a) indicates results of pattern matching between the matching region in FIG. 6(a) and the model pattern in FIG. 7(a). The 1×1 pixel located at the center, or row 7, column 7, in FIG. 11(a) is the position of a target pixel to which a score is assigned. Hereinafter, a horizontal train of pixels will be referred to as a “column,” and a vertical train of pixels will be referred to as a “row.” The rows are counted from the top, and the columns are counted from the left. Meshed parts indicate those pixels for which the matching region and the model pattern match in gradient direction.

The matching pattern in FIG. 11(b) shows a table for a case where the number of types of matching directions is taken into consideration. In this example, the matching pattern shows that there is a matching pixel present for all the 8 directions.

Next, the calculation of the matching pixel count in FIG. 11(b) shows an example of a method of calculating a matching pixel count for the meshed parts from the upper left pixel at row 1, column 1 to the lower right pixel at row 13, column 13. In the calculation, of the pixels having a gradient direction, “1” is assigned to those pixels having a gradient direction which matches the gradient direction in the model pattern, and “0” is assigned to the null direction pixels and those pixels having a gradient direction which does not match the gradient direction in the model pattern. The pixels determined to have null direction may be excluded throughout the calculation. The calculation gives the meshed matching pixel count at 85 in this example. The matching pixel count may be used as the score (correspondence degree) with or without the following normalization of the matching pixel count (correspondence degree).

Next, the normalized matching pixel count shown in FIG. 11(b) will be described. In this normalization of a matching pixel count, the matching pixel count is normalized as quantities independent from the sizes of model patterns when, for example, two or more model patterns are prepared for matching precision improvement in pattern matching (for example, three model patterns of 21×21, 13×13, and 7×7 pixels).

Here, the normalized matching pixel count is defined by equation (6) below:

Normalized Matching Pixel Count=Appropriate Constant×(Matching Pixel Count/Number of Elements Having Directional Component in Model) (6)

The “appropriate constant” is determined in a suitable manner in consideration of convenience in calculation and other factors. The constant is set here to 10 so that the normalized matching pixel count falls in a range of 0 to 10. The normalized matching pixel count is used also in the following example of pattern matching, of which description is omitted.

The normalized matching pixel count for the case of FIG. 11(a) is calculated from equation (6) as follows:

Normalized Matching Pixel Count=10×(85/136)=6.25≈6

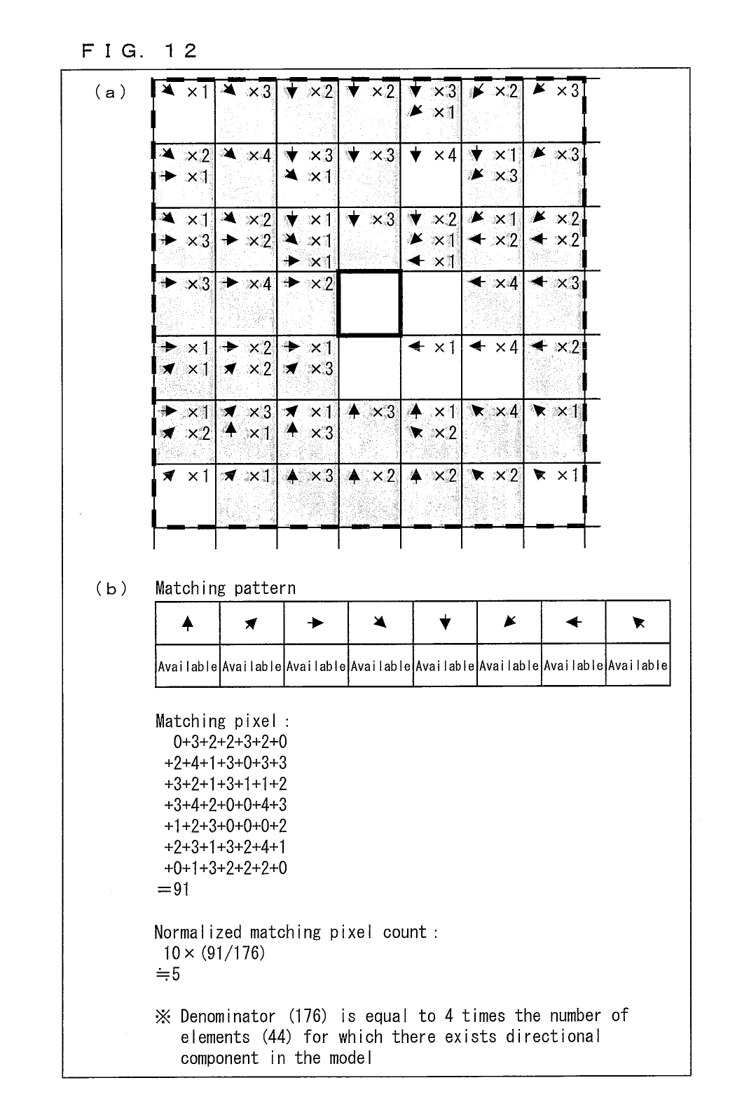

Next, FIG. 12(a) depicts pattern matching between a matching region and a model pattern in a dark environment subsequent to matching efficiency improvement. FIG. 11(b) depicts an exemplary correspondence degree calculation method for the pattern matching.

FIG. 12(a) indicates results of pattern matching between a matching region in FIG. 6(b) subsequent to matching efficiency improvement and the model pattern in FIG. 8(a). The 1×1 pixel (referred to as the “pixel” for convenience although it corresponds to 2×2 pixels) located at the center, or row 4, column 4, in FIG. 12(a) is the position of a target pixel to which a score is assigned. Meshed parts indicate those pixels for which the matching region and the model pattern match in gradient direction.

The matching pattern in FIG. 12(b) shows a table for a case where the number of types of matching directions is taken into consideration. In this example, the matching pattern shows that there is a matching pixel present for all the 8 directions.

Next, the calculation of the matching pixel count in FIG. 12(b) shows an example of a method of calculating a matching pixel count for the meshed parts from the upper left pixel at row 1, column 1 to the lower right pixel at row 7, column 7. Here, for example, at row 1, column 2, in the matching region, there are “three” pixels for which the gradient direction points at the “lower right.” In contrast, there is one gradient direction in the model pattern which points at the “lower right.” Therefore, the matching pixel count in this case is calculated to be “3.”

In another example, at row 2, column 1, in the matching region, there are “two” pixels for which the gradient direction points at the “lower right” and “one” pixel for which the gradient direction points at the “right.” In contrast, there is one gradient direction in the model pattern which points at the “lower right.” There are “two” matching “lower right” gradient directions and no matching “right” gradient directions. Therefore, the matching pixel count in this case is calculated to be “2.” The pixels determined to have null direction here is excluded throughout the calculation.

Performing this calculation on all the pixels yields a result indicating that the matching pixel count for the meshed parts is “91.” The matching pixel count may be used as the score (correspondence degree) with or without the following normalization of the matching pixel count.

Here, the normalized matching pixel count defined by equation (7) below:

Normalized Matching Pixel Count=Appropriate Constant×(Matching Pixel Count/4 Times Number of Elements Having Directional Component in Model) (7)

where the constant is set here to 10.

The normalized matching pixel count for the case of FIG. 11(a) is calculated from equation (7) as follows:

Normalized Matching Pixel Count=10×(91/176)=5.17≈5

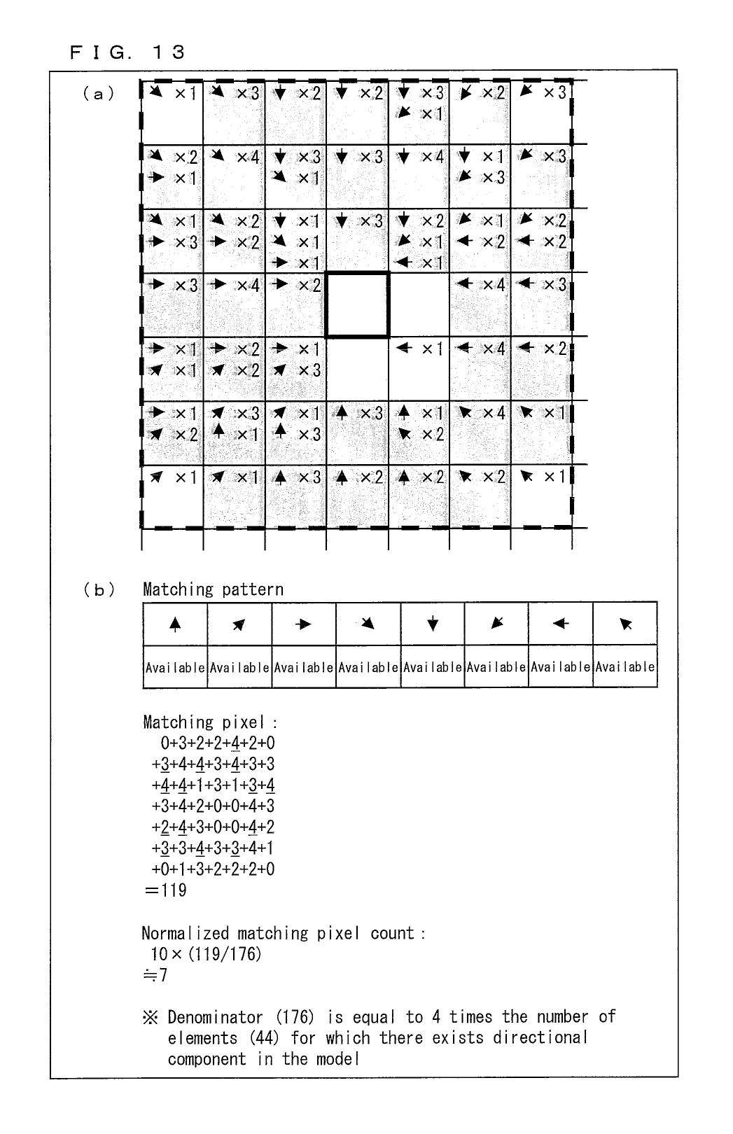

Next, FIG. 13(a) depicts pattern matching between a matching region and a model pattern in a dark environment subsequent to matching efficiency improvement. FIG. 13(b) depicts an exemplary correspondence degree calculation method for the pattern matching.

FIG. 13(a) indicates results of pattern matching between the matching region in FIG. 6(b) subsequent to matching efficiency improvement and the model pattern in FIG. 9(a). The 1×1 pixel (referred to as the “pixel” for convenience although it corresponds to 2×2 pixels) located at the center, or row 4, column 4, in FIG. 13(a) is the position of a target pixel to which a score is assigned. Meshed parts indicate those pixels for which the matching region and the model pattern match in gradient direction.

The matching pattern in FIG. 13(b) shows a table for a case where the number of types of matching directions is taken into consideration. In this example, the matching pattern shows that there is a matching pixel present for all the 8 directions.

Next, the calculation of the matching pixel count in FIG. 13(b) shows an example of a method of calculating a matching pixel count for the meshed parts from the upper left pixel at row 1, column 1 to the lower right pixel at row 7, column 7. Here, for example, at row 1, column 2, in the matching region, there are “three” pixels for which the gradient direction points at the “lower right.” In contrast, there are two gradient directions in the model pattern: one pointing at the “lower right” and the other pointing at the “bottom.” Since the matching region and the model pattern match in the “lower right,” the matching pixel count in this case is calculated to be “3.”

In another example, at row 2, column 1, in the matching region, there are “two” pixels for which the gradient direction points at the “lower right” and “one” pixel for which the gradient direction points at the “right.” In contrast, there are two gradient directions in the model pattern: one pointing at the “right” and the other pointing at the “lower right.” There are “one” “right” matching gradient direction and “two” “lower right” matching gradient directions. Therefore, the matching pixel count in this case is calculated to be “3.” The pixels determined to have null direction here is excluded throughout the calculation.

Some numerals are underscored while the others are not. The underscored numerals indicate that the matching pixel count is increased over the case of FIG. 12(a).

This results demonstrate that the use of the model pattern in FIG. 9(a) enables pattern matching that is more resistant to deformation (more robust to strain from the round shape) than the use of the model pattern in FIG. 8(a).

Performing this calculation on all the pixels yields a result indicating that the matching pixel count for the meshed parts is “119.” The matching pixel count may be used as the score (correspondence degree) with or without the following normalization of the matching pixel count.

The normalized matching pixel count for the case of FIG. 13(a) is calculated from equation (7) as follows:

Normalized Matching Pixel Count=10×(119/176)=6.76≈7

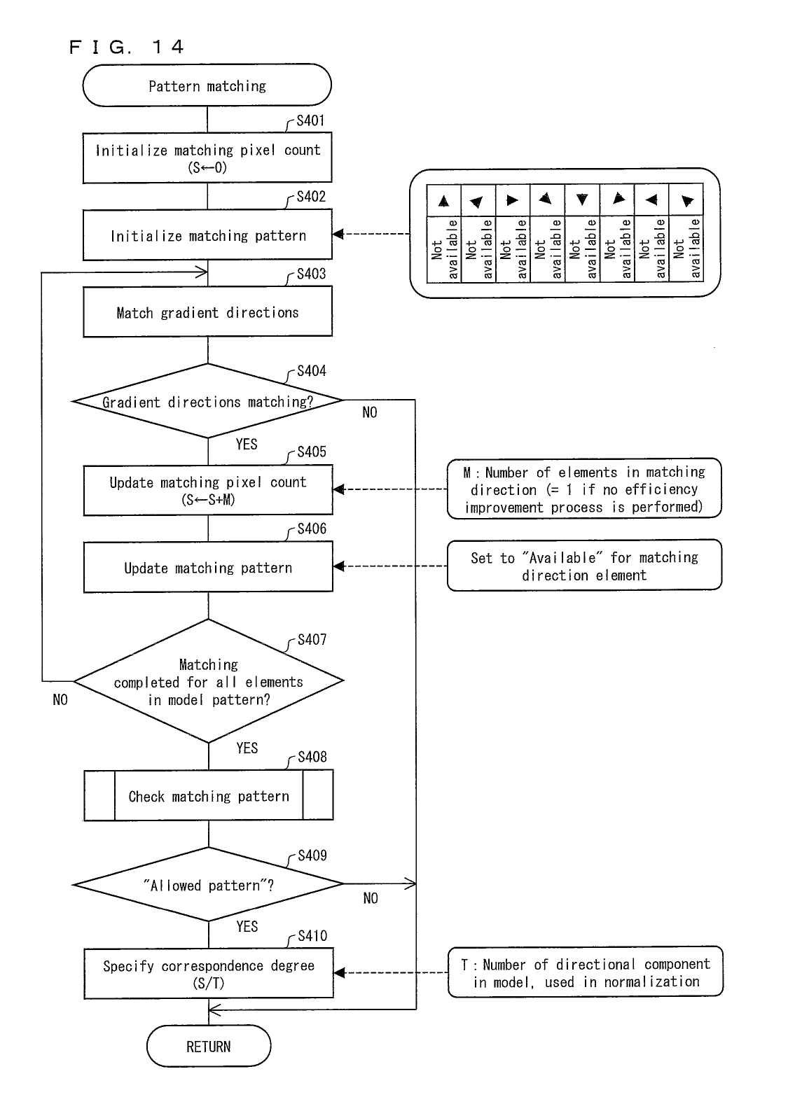

Next, referring to FIGS. 14 to 17, the score calculation section 10 in FIG. 1 using the matching pixel count and the correspondence pattern together to calculate the score (correspondence degree) will be described.

FIG. 14 is a flow chart of the matching pixel count and the pattern correspondence degree being used together in the pattern matching in the image processing device 1.

In FIG. 14, at S401, the matching pixel count calculation section 7 initializes the matching pixel count. The operation then continues at S402 where the pattern correspondence degree calculation section 9 initializes the matching pattern. The operation then proceeds to S403. The figure shows the number of types of gradient directions having been initialized, which is reflected in the “Not available” display for all the gradient directions.

In S403, the matching pixel count calculation section 7 and the pattern correspondence degree calculation section 9 carry out gradient direction matching, etc. for each pixel (including those pixels having been subjected to matching efficiency improvement). The operation then proceeds to S404.

A configuration may be employed which is used together with a case where the edge extraction section 4 determines valid pixels using an edge mask immediately before S403. In that case, a single device enables pattern matching both in backlight reflection base and in shadow base.

In S404, if directions match (Yes), the operation continues at S405 where the matching pixel count calculation section 7 adds the number of elements with matching directions (“1” when no efficiency improvement is carried out) to the matching pixel count. The operation then proceeds to S406. On the other hand, if there are no pixels at all for which the directions match (No), the operation returns to S401.

In S406, the pattern correspondence degree calculation section 9 updates the matching gradient direction to “Available” before the operation proceeds to S407.

In S407, if the matching pixel count calculation section 7 and the pattern correspondence degree calculation section 9 have completed the matching for all the elements (pixels) in the model pattern (Yes), the operation proceeds to S408; if the sections 7 and 9 have not completed the matching (No), the operation returns to S403.

In S408, the pattern correspondence degree calculation section 9 checks the matching pattern. The operation then proceeds to S409. The checking of the matching pattern will be described later in detail.

In S409, the pattern correspondence degree calculation section 9 determines whether it is a “allowed pattern” in reference to the model pattern and comparative matching pattern storage section 8. If it is an allowed pattern (Yes), the operation proceeds to S410. On the other hand, if it is not an allowed pattern (No), the operation returns to S404. In this case, the pattern correspondence degree calculation section 9 may set the pattern correspondence degree to “1” if it is an “allowed pattern” and to “0” if it is not an “allowed pattern” so that the score calculation section 10 can multiply the matching pixel count calculated by the matching pixel count calculation section 7 by these values.

In S410, the score calculation section 10 calculates the normalized matching pixel count from the matching pixel count calculated by the matching pixel count calculation section 7 as the score (correspondence degree) for the pattern matching.

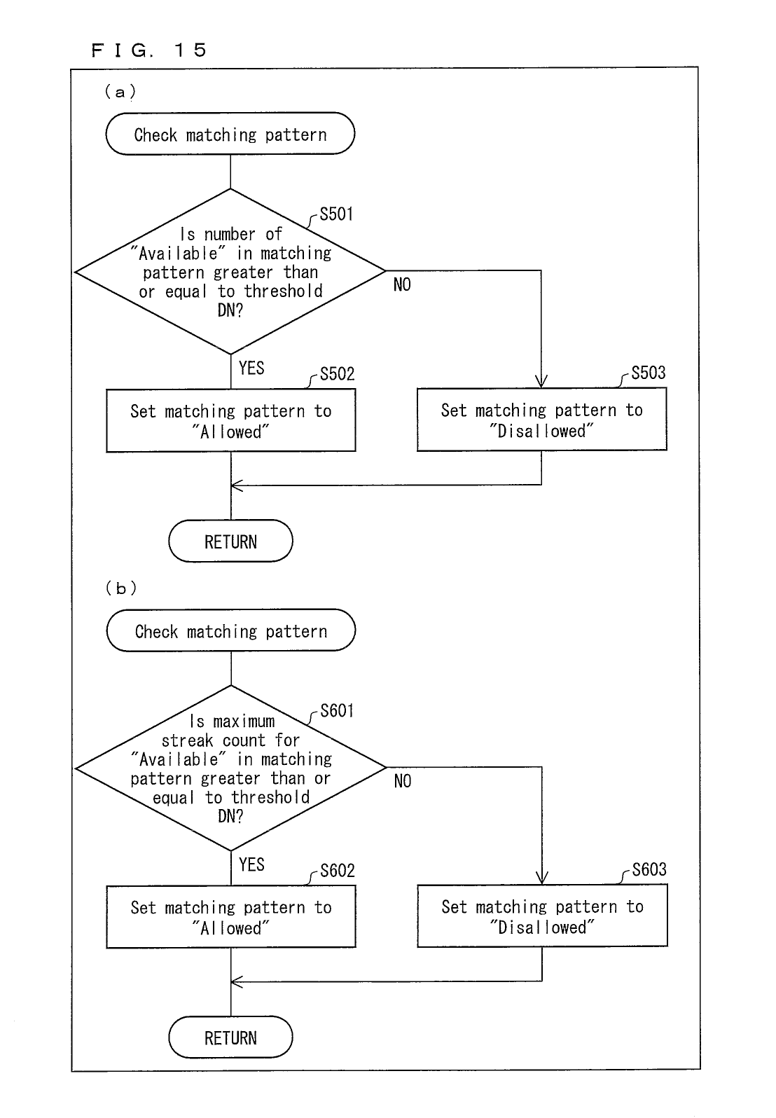

Next, referring to FIGS. 15(a) and 15(b), an example of the checking of a matching pattern in the pattern matching will be described.

FIG. 15(a) depicts an exemplary pattern correspondence degree calculation process. FIG. 15(b) depicts another exemplary pattern correspondence degree calculation process.

The description here assumes 8 gradient directions and a threshold (DN) of 5 for the number of types of gradient directions.

As shown in FIG. 15(a), in S501, if the number of “Available” in the matching pattern is greater than or equal to 5, the operation proceeds to S502 where the pattern correspondence degree calculation section 9 allows the matching pattern.

On the other hand, if the number of “Available” (number of types of gradient directions) in the matching pattern is less than 5, the operation proceeds to S503 where the pattern correspondence degree calculation section 9 disallows matching pattern.

The flow from S601 to S603 in FIG. 15(b) is the same as the flow from S501 to S503 in FIG. 15(a), except that in the former, the pattern correspondence degree calculation section 9 calculates a maximum streak count (number of successive matches) in the matching pattern and sets a threshold (DN) for the maximum streak count (number of successive matches) in the matching pattern to 5 (equal to the value in the above case), of which description is omitted.

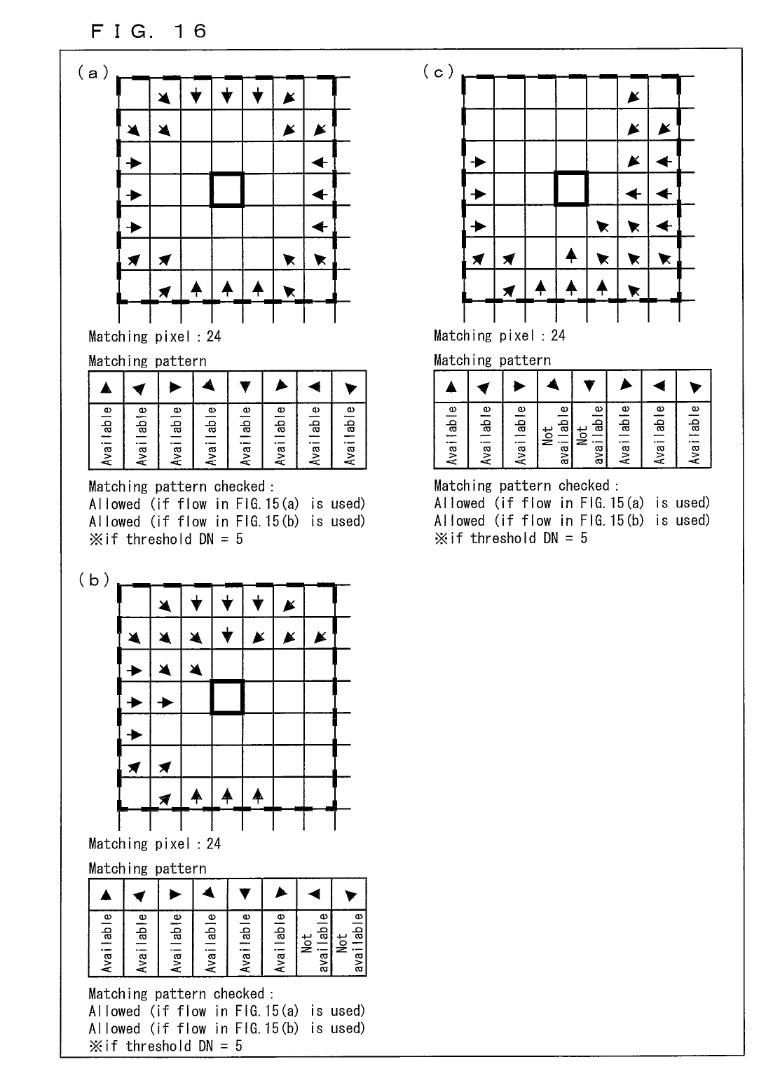

Next, referring to FIGS. 16(a) to 16(c), an example of the checking of a matching pattern will be described.

FIG. 16(a) depicts an exemplary pattern correspondence degree calculation process. FIG. 16(b) depicts another exemplary pattern correspondence degree calculation process. FIG. 16(c) depicts a further exemplary pattern correspondence degree calculation process.

In FIG. 16(a), the matching pixel count is calculated to be “24.” In addition, the matching pattern for gradient direction contains all the “8” directions which exceeds the threshold, 5. The matching pattern is determined to be an “allowed pattern” in FIG. 15(a). Meanwhile, the maximum streak count in the matching pattern, or the number of “Available” in a streak, is “8” which exceeds the threshold, 5. The matching pattern is determined to be an “allowed pattern” again in FIG. 15(b). Therefore, in the case of FIG. 16(a), the pattern correspondence degree calculation section 9 calculates the pattern correspondence degree to be “1,” and the score calculation section 10 first multiplies the matching pixel count, “24,” calculated by the matching pixel count calculation section 7 with “1” and then calculates the normalized matching pixel count as a score.

In FIG. 16(b), the matching pixel count is calculated to be “24.” In addition, the matching pattern for gradient direction contains “6” directions which exceeds the threshold, 5. The matching pattern is determined to be an “allowed pattern” in FIG. 15(a). Meanwhile, the maximum streak count in the matching pattern, or the number of “Available” in a streak, is “6” which exceeds the threshold, 5. The matching pattern is determined to be an “allowed pattern” again in FIG. 15(b). Therefore, in the case of FIG. 16(b), the pattern correspondence degree calculation section 9 calculates the pattern correspondence degree to be “1,” and the score calculation section 10 first multiplies the matching pixel count, “24,” calculated by the matching pixel count calculation section 7 with “1” and then calculates the normalized matching pixel count as a score.

In FIG. 16(c), the matching pixel count is calculated to be “24.” In addition, the matching pattern for gradient direction contains “6” directions which exceeds the threshold, 5. The matching pattern is determined to be an “allowed pattern” In FIG. 15(a). Meanwhile, the maximum streak count in the matching pattern, or the number of “Available” in a streak, is “6” which exceeds the threshold, 5. The matching pattern is determined to be an “allowed pattern” again in FIG. 15(b). Note that, as in the example, the maximum streak count in the matching pattern is calculated assuming that the left-hand end and the right-hand end of the matching pattern table are joined together (periodical interface conditions).

From the results above, in the case of FIG. 16(c), the pattern correspondence degree calculation section 9 calculates the pattern correspondence degree to be “1,” and the score calculation section 10 first multiplies the matching pixel count, “24,” calculated by the matching pixel count calculation section 7 with “1” and then calculates the normalized matching pixel count as a score.

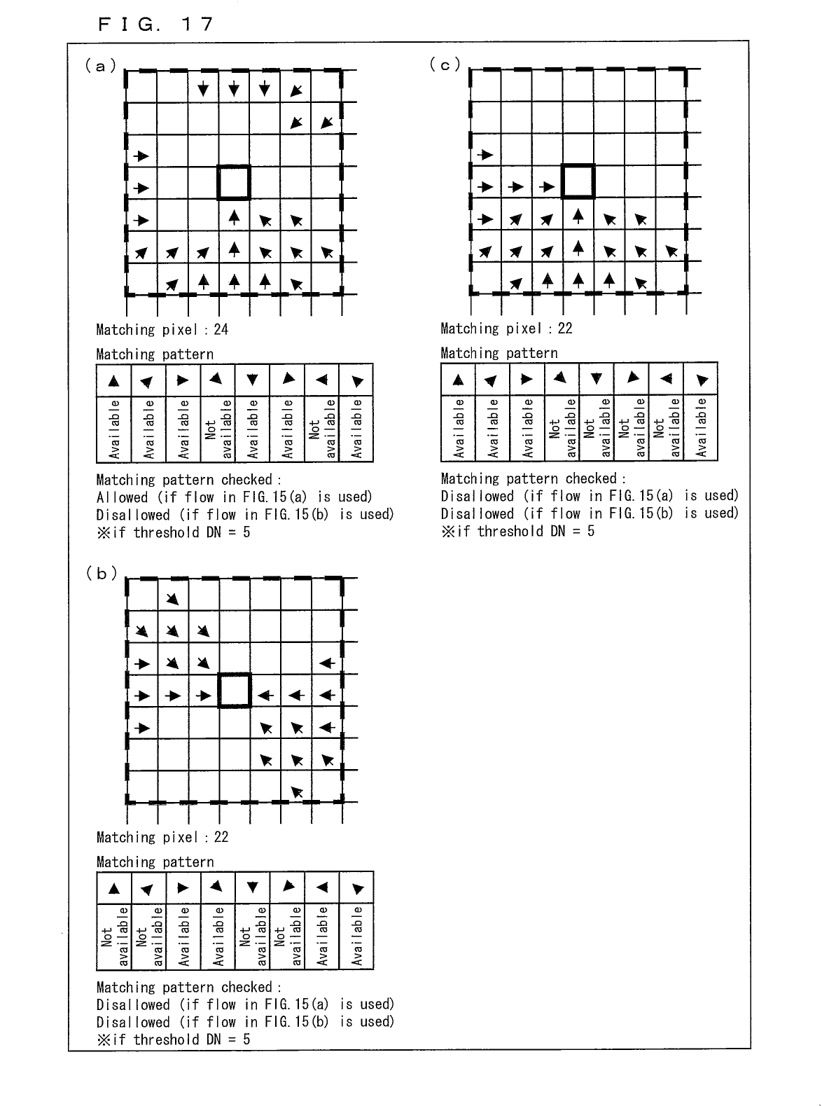

Next, referring to FIGS. 17(a) to 17(c), another example of the checking of a matching pattern will be described.

FIG. 17(a) depicts still another exemplary pattern correspondence degree calculation process. FIG. 17(b) depicts yet another exemplary pattern correspondence degree calculation process. FIG. 17(c) depicts further yet another exemplary pattern correspondence degree calculation process.

In FIG. 17(a), the matching pixel count is calculated to be “24.” In addition, the matching pattern for gradient direction contains “6” directions which exceeds and the threshold, 5. The matching pattern is determined to be an “allowed pattern” in FIG. 15(a). Meanwhile, the maximum streak count in the matching pattern, or the number of “Available” in a streak, is “4” which is less than or equal to the threshold, 5. The matching pattern is determined to be a “disallowed pattern” in FIG. 15(b). Therefore, in the case of FIG. 17(a), in the case of using FIG. 15(a), the pattern correspondence degree calculation section 9 calculates the pattern correspondence degree to be “1,” and the score calculation section 10 first multiplies the matching pixel count, “24,” calculated by the matching pixel count calculation section 7 with “1” and then calculates the normalized matching pixel count as a score. In addition, in the case of using FIG. 15(b), the pattern correspondence degree calculation section 9 calculates the pattern correspondence degree to be “0,” and the score calculation section 10 multiplies the matching pixel count, “24,” calculated by the matching pixel count calculation section 7 with “0” to obtain a score, “0.”

In FIG. 17(b), the matching pixel count is calculated to be “22.” In addition, the matching pattern for gradient direction contains “4” directions which is less than or equal to the threshold, 5. The matching pattern is determined to be a “disallowed pattern” in FIG. 15(a). Meanwhile, the maximum streak count in the matching pattern, or the number of “Available” in a streak, is “2” which is less than or equal to the threshold, 5. The matching pattern is determined to be a “disallowed pattern” again in FIG. 15(b). Therefore, in the case of FIG. 17(b), the pattern correspondence degree calculation section 9 calculates the pattern correspondence degree to be “0,” and the score calculation section 10 multiplies the matching pixel count, “22,” calculated by the matching pixel count calculation section 7 with “0” to obtain a score, “0.”

In FIG. 17(c), the matching pixel count is calculated to be “22.” In addition, the matching pattern for gradient direction contains “4” directions which is less than or equal to the threshold, 5. The matching pattern is determined to be a “disallowed pattern” in FIG. 15(a). Meanwhile, the maximum streak count in the matching pattern, or the number of “Available” in a streak, is “4” which exceeds the threshold, 5. The matching pattern is determined to be a “disallowed pattern” again in FIG. 15(b).

From the results above, in the case of FIG. 17(c), the pattern correspondence degree calculation section 9 calculates the pattern correspondence degree to be “0,” and the score calculation section 10 multiplies the matching pixel count, “22,” calculated by the matching pixel count calculation section 7 with “0” to obtain a score, “0.”

As described in the foregoing, the score calculation section 10 matches the matching region with the model pattern and calculates the score (correspondence degree) from the number of pixels (matching pixel count) for which the gradient direction contained in the matching region matches the gradient direction contained in the model pattern and a pattern correspondence degree which is a degree of similarity of the matching pattern between the gradient direction for each pixel in the matching region and the gradient direction for each pixel in the model pattern to the predetermined comparative matching pattern.

A scalar quantity, such as a pixel value (density level), could possibly be used as the quantity used in the matching of a matching region with a predetermined model pattern (hereinafter, may be referred to as the “pattern matching”). It is however difficult to set up model patterns in advance because the scalar quantity, even when quantized (values within a predetermined range are treated by equally regarding them as a particular constant), is ever variable depending on, for example, the condition of the image capture object.

Meanwhile, the gradient of the pixel value is a vector quantity with both a magnitude (gradient magnitude) and a direction (gradient direction). Especially, the gradient direction (orientation), for example, when quantized into 8 directions, enables discretization of any potential states for the pixels with as few as 8 states (or 9 if null direction is included), which is an extremely small number. Furthermore, the discretized states render different directions readily distinguishable.

The gradient directions generally match a direction either from an edge part in the captured image to near the center of an area surrounded by the edge part or radially from near the center toward the edge part, for example, for the finger surface or like soft surface which forms a round contact face upon contact with another surface and for the round-tipped pen or like surface which forms a round contact face despite its hardness. For contact faces of other shapes, the gradient directions again generally match a direction either from an edge part in the captured image to the inside of an area surrounded by the edge part or from the inside of an area surrounded by an edge part toward the outside of the area.

When the image capture object does not touch on the captured image, for example, when the image capture object is a finger pad, edges may in some cases result from a large blurry shadow of those fingers which are not in contact. In addition, for example, when the input device (photo sensor) or the sensing circuit has a defect, the defect may cause a band or line of noise with accompanying edges.

If these pattern-matching-disrupting edges (hereinafter, “unnecessary edges”) have occurred, the matching pixel count may be increased locally (only in one or two directions) even when the number of pixels in the model pattern is increased. Therefore, when such an unnecessary edge is present, the matching pixel count alone would be insufficient to achieve correct recognition and suitable pattern matching.

Accordingly, for example, when the finger or the pen has come in contact, if the matching pixel count and the correspondence pattern (for example, the number of types of gradient directions) are used together based on an assumption that at least 6 or more gradient directions, if not all the 8 directions (which would be ideal), should appear, the cases where the correspondence degree is increased due to the local increases in the matching pixel count (only in one or two directions) can be excluded.

Therefore, robustness to noise and deformation in image input would be improved by using both the matching pixel count and the pattern correspondence degree in the pattern matching.

In such a situation, considering image capture environment, it is preferable to set up a threshold in backlight reflection base on an assumption that the number of types of gradient directions is greater than or equal to 6 and to set up a threshold in shadow base on an assumption that the number of types of gradient directions is greater than or equal to 4. This is because, as described in the following in reference to FIG. 2, the image capture object appears as a white blurry round figure in its captured image in backlight reflection base, whilst in shadow base, the image capture object appears as a white blurry round figure along with surrounding shadow in its image capturing, and the gradient directions of the shadow have features which are not completely circular, but semicircular.

Hence, the image processing device 1, as an example, is provided which, irrespective of detection of a touch/non-touch of the captured image with the image capture object, can detect the position in the captured image pointed at with the image capture object with small memory and short processing time by performing the pattern matching using image data for only one frame and which can also improve the robustness to noise in image input and deformation of the captured image in the pattern matching.

Therefore, the robustness to noise in image input and deformation of the captured image is improved in the pattern matching.

If the matching pixel count and the number of successive matches are used together based on an assumption that at least 6 or more successive matches should appear similarly to the number of types of corresponding directions, the cases where the correspondence degree is increased due to the local increases in the matching pixel count (only in one or two directions) can be excluded.

Therefore, the robustness to noise in image input and deformation of the captured image is improved in the pattern matching. In addition, the use of the number of successive matches in place of the number of types of gradient directions in the calculation of the pattern correspondence degree enables more rigorous pattern matching and more reliable exclusion of wrong recognition.

As mentioned earlier, the comparison matching pattern is preferably the number of types of corresponding directions for the gradient direction for each pixel in the matching region and the gradient direction for each pixel in the model pattern.

If the matching pixel count and the number of types of gradient directions are used together based on an assumption that at least 6 or more gradient directions should appear as in the aforementioned example, wrong recognition can be excluded by excluding the cases where the correspondence degree is increased due to the local increases in the matching pixel count (only in one or two directions).

Therefore, the robustness to noise in image input and deformation of the captured image is improved in the pattern matching.

In addition, the comparison matching pattern is preferably the number of successive matches (number of successive matches of types of corresponding directions for the gradient direction for each pixel in the matching region and the gradient direction for each pixel in the model pattern).

If the matching pixel count and the number of successive matches are used together based on an assumption that at least 6 or more successive matches should appear similarly to the number of types of corresponding directions, the cases where the correspondence degree is increased due to the local increases in the matching pixel count (only in one or two directions) can be excluded.

Therefore, the robustness to noise in image input and deformation of the captured image is improved in the pattern matching. In addition, the use of the number of successive matches in place of the number of types of gradient directions in the calculation of the pattern correspondence degree enables more rigorous pattern matching and more reliable exclusion of wrong recognition.
6. Pointing Position Identification Process

Next, referring to FIGS. 1 and 18 to 20, the pointing position identification process in the image processing device 1 will be described.

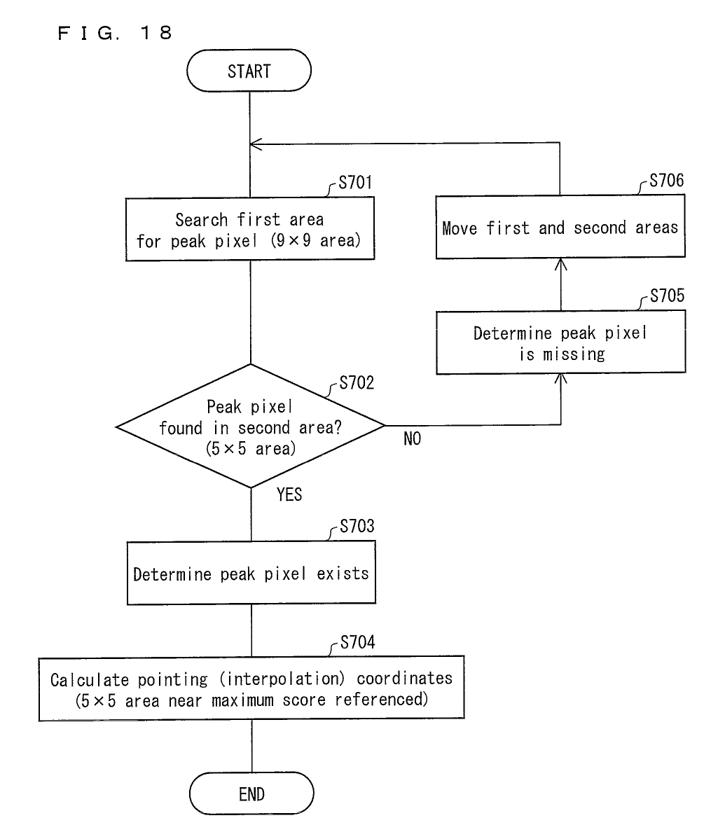

FIG. 18 is a flow chart for a part of the operation of the image processing device 1, or the pointing position coordinate calculation process.

In S701, the peak search section 12 searches a first area (search area) containing a predetermined number of pixels around the target pixel for a peak pixel which is a pixel for which the correspondence degree calculated by the score calculation section 10 is a maximum. Upon the section 12 finding such a peak pixel, the operation proceeds to S702. If the peak search section 12 cannot find the peak pixel (not shown), the target pixel is shifted by a predetermined number (for example, the shortest path from the target pixel in the first area to a pixel on an edge (length of a side of a second area)). The operation then returns to S701.

If the coordinate calculation determining section 13 has in S702 determined that the peak pixel found by the peak search section 12 is present in the second area (sub-area) which contains the same target pixel as does the first area, which contains a predetermined number of pixels that is less than the number of pixels in the first area, and which is also completely enclosed in the first area, the operation then continues at S703 where the coordinate calculation determining section 13 determines “it has found the peak pixel.” The operation then proceeds to S704. On the other hand, if the coordinate calculation determining section 13 has determined that the peak pixel found by the peak search section 12 is not present in the second area (sub-area), the operation continues at S705 where the coordinate calculation determining section 13 determines “it has found no peak pixel.” the target pixel is shifted by a predetermined number (for example, the shortest path from the target pixel in the first area to a pixel on an edge (length of a side of a second area)). The operation then returns to S701.

This operation is repeated until the coordinate calculation section 14 calculates the pointing (interpolation) position.

In S704, the coordinate calculation section 14 calculates the position in the captured image pointed at with the image capture object by using the score for each pixel in a peak pixel region which is a region containing a predetermined number of pixels centered around the peak pixel found by the peak search section 12, which brings the operation to the “END.”

The above description assumes that the operation is repeated until the coordinate calculation section 14 calculates the pointing (interpolation) position. Alternatively, two or more pointing (interpolation) positions may be calculated, in which case, the first and second areas are moved until the operation as shown in the flow chart in FIG. 18 is carried out across the entire image.

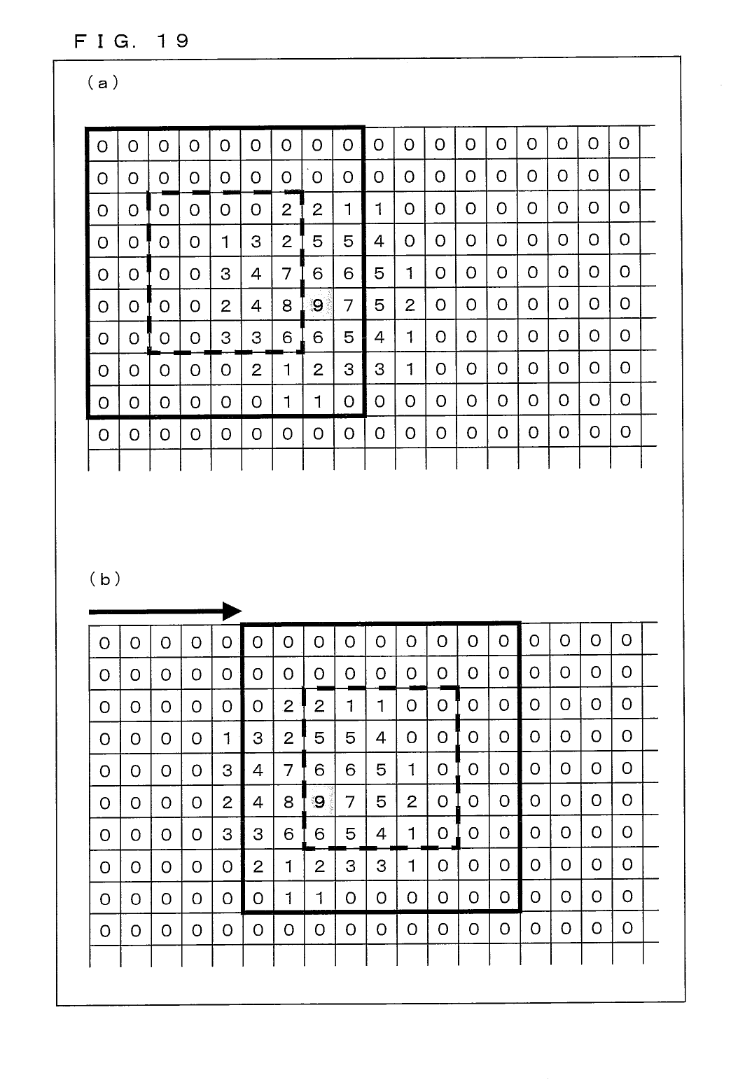

Next, referring to FIGS. 19(a) and 19(b), a concrete example of determining presence/absence of the peak pixel will be described.

FIG. 19(a) depicts the operation in the case of the coordinate calculation determining section 13 in the image processing device 1 determining that there is no peak pixel. FIG. 19(b) depicts the operation in the case of the coordinate calculation determining section 13 determining that there is a peak pixel.

The solid line in FIG. 19(a) indicates the first area, and the broken line indicates the second area. The first area contents 9×9 pixels. The second area contains 5×5 pixels. Both areas contains “odd number×odd number” pixels so that there is one target pixel at the center.

In the example in FIG. 19(a), the first area contains a peak pixel, “9,” whereas the second area contains no peak pixel. Therefore, in this case, the coordinate calculation determining section 13 determines “it has found no peak pixel.”

On the other hand, in the example in FIG. 19(b), the first area contains a peak pixel, “9,” and the second area also contains that peak pixel. Therefore, in this case, the coordinate calculation determining section 13 determines “it has found the peak pixel.”

In the example above, the difference in the number of pixels between the first area and the second area is set up so that the peak pixel can always move into the second area, by moving the first area and the second area by “5 pixels” which is the shortest path from the target pixel in the first area to a pixel on an edge (length of a side of a second area), if the first area contains a peak pixel whilst the second area contains no peak pixel.

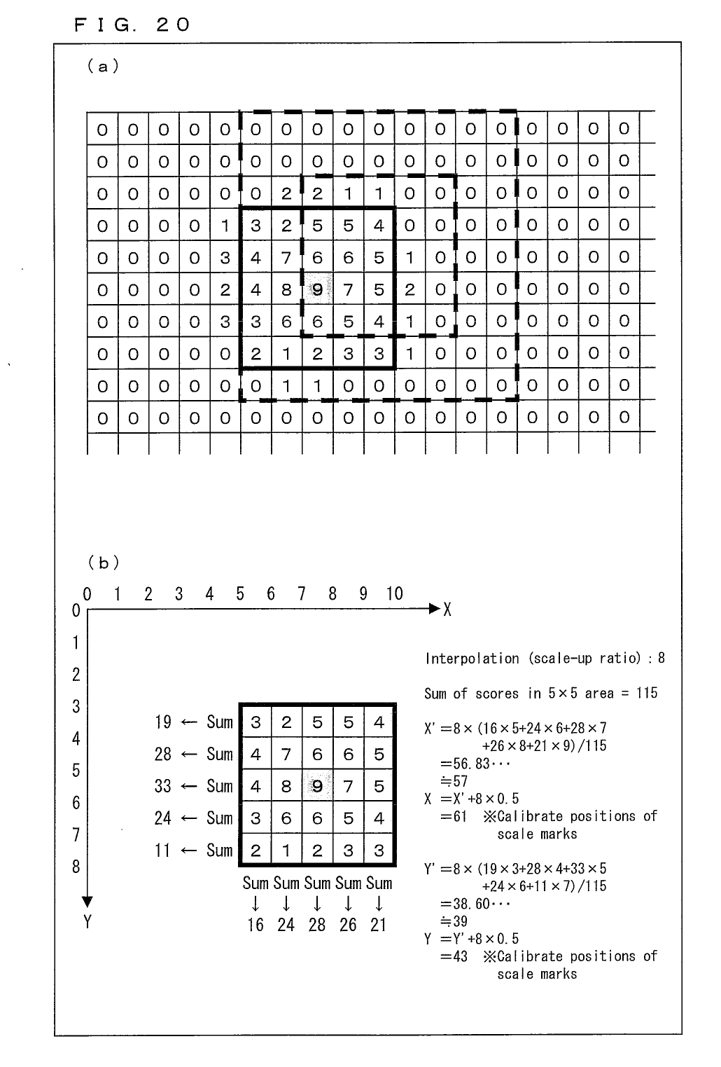

Next, referring to FIGS. 20(a) and 20(b), a pointing (interpolation) coordinate (position in the captured image pointed at with the image capture object) calculation method for the coordinate calculation section 14 will be described.

FIG. 20(a) depicts a peak pixel region used for the calculation of a position in a captured image pointed at with an image capture object in the image processing device 1. FIG. 20(b) depicts a coordinate calculation method for a pointing (interpolation) coordinate in the image processing device 1.

FIG. 20(a) shows a case where the coordinate calculation determining section 13 has determined “there is a peak coordinate” as in the case of FIG. 19(b).

FIG. 20(a) shows both the first and the second area as areas bounded by broken lines. Meanwhile, the 5×5-pixel region bounded by solid lines is the peak pixel region which is a region containing a predetermined number of pixels centered around a peak pixel.

In example in FIG. 20(a), the peak pixel region is also completely contained in the first area as is the second area. In this case, the score in the peak pixel region does not need to be examined again. In this manner, the peak pixel region is preferably contained in the first area even when the second area contains a peak pixel on an edge.

Next, referring to FIG. 20(b), a pointing coordinate calculation method for the coordinate calculation section 14 will be described.

This example assumes that when the image data contains 320×240 pixels, the resolution reduction section 2 shown in FIG. 1 carries out bilinear downscaling twice, the matching efficiency improving section 6 carries out matching efficiency improvement on 2×2 pixels, and the score image (score data assigned for each pixel) is made up of 80×60 pixels.

Therefore, the entire area of the score image scaled up by 8 corresponds to the entire area of the image data. Therefore, interpolation quantity (scale-up ratio)=8.

The following will describe a specific calculation method. First, the sum of scores is calculated for each row in the peak pixel region (19, 28, 33, 24, and 11 in FIG. 20(b)). Next, the sum of scores is calculated for each column in the peak pixel region (16, 24, 28, 26, and 21 in FIG. 20(b)). In addition, the grand sum of the scores in the peak pixel region (5×5 pixels) is obtained (115 in FIG. 20(b)).

Next, assuming that the score in the peak pixel region corresponds to a mass distribution, the coordinates of the center of mass in the entire area of the score image is obtained. That is followed by scaling up by 8, to yield the coordinates as in equations (8) and (9) below:

$$\begin{matrix}Math . 2 & \\ {X}^{′} = 8 \times ( \frac{\begin{matrix}16 \times 5 + 24 \times 6 + 28 \times \\ 7 + 26 \times 8 + 21 \times 9\end{matrix}}{115} ) = 56.83 \approx 57 & ( 8 ) \\ Math . 3 & \\ {Y}^{′} = 8 \times ( \frac{\begin{matrix}19 \times 3 + 28 \times 4 + 33 \times \\ 5 + 24 \times 6 + 11 \times 7\end{matrix}}{115} ) = 38.60 \approx 39 & ( 9 )\end{matrix}$$

Next, by calibrating the positions of the scale marks with pixel size taken into consideration, the pointing coordinates (X, Y) are given by equation (10) below:

Math. 4

(X, Y)=(X′+8×0.5,Y′+8×0.5)=(61,43) (10)

From the description above, the peak search section 12 searches the first area (search area). Hence, the processing cost and the memory size are reduced over searching the image data region containing the total pixel count for a peak pixel.

For example, a small number of pixels being contained in the first area means that the scores for the entire data image (score image) (=all pixels) do not need to be stored in a buffer and also that the memory size does not need to be greater than required by the first area where a peak search is executed (for example, a line buffer for 9 lines for a 9×9-pixel first area).

This memory size reduction effect by way of implementation with a line buffer is achievable not only with a peak search, but also with temporarily storage for the vertical and horizontal gradient quantities, temporarily storage for gradient directions, and any like implementation where buffer memory is used to given data over to a later process.

The coordinate calculation section 14 calculates the pointing position by using the score for each pixel in the peak pixel region which is a region containing a predetermined number of pixels centered around the peak pixel found by the peak search section 12. For example, when the pointing position is to be obtained from its center of mass position by using its edge image, the calculation would become increasingly difficult with deformation of the captured image.

However, in the image processing device 1, the pointing position is calculated by using the score for each pixel in the peak pixel region obtained by pattern matching. Even if the captured image is deformed, the neighborhood of a maximum of the score in the pattern matching would be regarded as exhibiting a substantially similar tendency in distribution to the tendency before the deformation where the correspondence degree decreases radially from the neighborhood of the maximum.

Therefore, the pointing position can be calculated by predetermined procedures (for example, calculation of a center of mass for the score in the peak pixel region) regardless of whether or not the captured image is deformed. Hence, the amount of image processing, the processing cost, and the memory size are all reduced in the calculation of the pointing position while maintaining precision in the coordinate position detection.

Hence, the image processing device 1, as an example, is provided which, irrespective of detection of a touch/non-touch of the captured image with the image capture object, can detect the pointing position with small memory and short processing time and can also reduce the amount of image processing, while maintaining precision in the detection of the pointing position, and the memory size in the calculation of the pointing position, by performing the pattern matching using image data for only one frame.

The coordinate calculation section 14 preferably calculates the pointing position if the coordinate calculation determining section 13 has determined that the peak pixel found by the peak search section 12 is present in the second area (sub-area) which contains the same target pixel as does the first area, which contains a predetermined number of pixels that is less than the number of pixels in the first area, and which is also completely enclosed in the first area.

The peak pixel region is a region around a peak pixel (as a target pixel) that is present in the second area. The peak pixel region therefore contains many common pixels to the first area. In addition, since the score has already been calculated for the common pixels for the peak pixel region and the first area, the coordinate calculation section 14 can calculate the pointing position if the score is examined for the non-common pixels.

The peak pixel region can be included in the first area if the number of pixels is regulated in both the peak pixel region and the first area. In that case, since the score for each pixel in the peak pixel region is already known, the yet-to-be-known score for each pixel does not need to be examined for the calculation of the pointing position.

Hence, the amount of image processing and the memory size are further reduced in the calculation of the pointing position. In addition, the buffer size can be reduced (for example, only 9 lines, not the entire image) for the storage of the scores referenced in, for example, dealing with the case where a streak of rising scores exists toward the outside of the first area in peak coordinate determination and pipelining for each processing module in hardware implementation, etc.
7. Touch/Non-Touch Detection

Next, an embodiment will be described in which the image capture object is determined to have touched the liquid crystal display device in the image processing device 1.

First, the score calculation section 10 preferably determines that the image capture object has touched the liquid crystal display device if a maximum of the score which the section 10 calculates exceeds a predetermined threshold.

The score calculation section 10 is assumed here to have such a function. Alternatively, a separate determining section with the same function may be provided.

In the configuration above, the image capture object is determined to have touched the liquid crystal display device if a maximum of the score exceeds a predetermined threshold. The configuration thus restrains wrong detection which could occur if the image capture object is regarded as having touched the liquid crystal display device whenever the score is calculated.

In addition, the score calculation section 10 preferably determines that the image capture object has touched the liquid crystal display device if the correspondence degree which the section 10 calculates exceeds a predetermined threshold.

The score calculation section 10 determines that the image capture object is in contact with the liquid crystal display device if the section 10 has calculated a score in excess of a predetermined threshold (sufficient correspondence degree), in other words, if image information from which similar features to a model pattern are obtained is input.

Therefore, the configuration can make a decision as to touch/non-touch in the image processing in which the pointing position is identified, without a dedicated device or a processing section being provided to determine touch/non-touch.

The edge extraction section 4 preferably determines that the image capture object has touched the liquid crystal display device if the section 4 has identified either the first edge pixels or the second edge pixels. In the present embodiment, the edge extraction section 4 is assumed to have the function. Alternatively, a separate touch/non-touch determining section with the same function may be provided.

As mentioned earlier, the light entering the built-in image capture sensors in the liquid crystal display device may be a mixture of reflection of the backlight and external light coming from the outside.

When this is the case, it is difficult to separate effects of the reflection of the backlight and effects of the external light coming from the outside from the captured image.

In backlight reflection base, the image obtained from the reflection of the backlight off the image capture object shows a blurred white round figure, for example, for a finger pad. Accordingly, in this case, the first threshold may be set to a relatively low value so that the touch/non-touch determining means can determine that the image capture object has touched the liquid crystal display device if the edge pixel identification means has identified the first edge pixels.

On the other hand, in shadow base, the captured image is blurred (low contrast) if the image capture object (for example, the finger pad) is positioned off the panel surface (non-touch) and sharp (high contrast) if the image capture object is in contact with the panel surface. Therefore, in shadow base, the second threshold may be set to a relatively high value so that the touch/non-touch determining means can determine that the image capture object has touched the liquid crystal display device if the edge pixel identification means has identified the second edge pixels in accordance with the second threshold that is more stringent (greater) than the first threshold.

Hence, the touch/non-touch detection becomes possible in backlight reflection base and in shadow base by simply setting up the relatively low first threshold and the relatively stringent second threshold. In addition, the determination as to a touch/non-touch can be made in the image processing in which the pointing position is identified, without a dedicated device or a processing section being provided to determine as to a touch/non-touch.

The present invention is not limited to the examples above of the image processing device (electronic apparatus), but may be altered by a skilled person within the scope of the claims. An embodiment based on a proper combination of technical means disclosed in different embodiments is encompassed in the technical scope of the present invention.

Finally, the blocks of the image processing device 1, especially, the resolution reduction section 2, the pixel-value vertical-gradient-quantity calculation section 3a, the pixel-value horizontal-gradient-quantity calculation section 3b, the edge extraction section 4, the gradient direction/null direction identifying section 5, the matching efficiency improving section 6, the matching pixel count calculation section 7, the pattern correspondence degree calculation section 9, the score calculation section 10, and the position identifying section 11, may be implemented by hardware or software executed by a CPU as follows:

The image processing device 1 includes a CPU (central processing unit) and memory devices (storage media). The CPU executes instructions contained in control programs, realizing various functions. The memory devices may be a ROM (read-only memory) containing computer programs, a RAM (random access memory) to which the programs are loaded, or a memory containing the programs and various data. The objective of the present invention can be achieved also by mounting to the image processing device 1 a computer-readable storage medium containing control program code (executable programs, intermediate code programs, or source programs) for the image processing device 1, which is software implementing the aforementioned functions, in order for a computer (or CPU, MPU) to retrieve and execute the program code contained in the storage medium.

The storage medium may be, for example, a tape, such as a magnetic tape or a cassette tape; a magnetic disk, such as a floppy® disk or a hard disk, or an optical disc, such as a CD-ROM/MO/MD/DVD/CD-R; a card, such as an IC card (memory card) or an optical card; or a semiconductor memory, such as a mask ROM/EPROM/EEPROM/flash ROM.

The image processing device 1 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, a wired line, such as IEEE 1394, USB, an electric power line, a cable TV line, a telephone line, or an ADSL; or wireless, such as infrared (IrDA, remote control), Bluetooth®, 802.11 wireless, HDR, a mobile telephone network, a satellite line, or a terrestrial digital network. The present invention encompasses a carrier wave, or data signal transmission, in which the program code is embodied electronically.

The image processing device in accordance with the present invention, being provided with the foregoing features, preferably further includes coordinate calculation determining means for causing the coordinate calculation means to calculate the pointing position if the coordinate calculation determining means has determined that the peak pixel found by the peak pixel search means is present in a sub-area which contains the same target pixel as does the search area, which contains a predetermined number of pixels that is less than a number of pixels in the search area, and which is also completely enclosed in the search area.

According to the configuration, the coordinate calculation determining means causes the coordinate calculation means to calculate the pointing position if the coordinate calculation determining means has determined that the peak pixel found by the peak pixel search means is present in a sub-area which contains a predetermined number of pixels that is less than a number of pixels in the search area and which is also completely enclosed in the search area.

The peak pixel region is a region around a peak pixel (as a target pixel) that is present in the sub-area. The peak pixel region therefore contains many common pixels to the search area. In addition, since the correspondence degree has already been calculated for the common pixels for the peak pixel region and the search area, the coordinate calculation means can calculate the pointing position if the correspondence degree is examined for the non-common pixels.

The peak pixel region can be included in the search area if the number of pixels is regulated in both the peak pixel region and the search area. In that case, since the correspondence degree for each pixel in the peak pixel region is already known, the yet-to-be-known correspondence degree for each pixel does not need to be examined for the calculation of the coordinates.

Hence, the amount of image processing and the memory size are further reduced in the calculation of the coordinate position.

The image processing device in accordance with the present invention, being provided with the foregoing features, preferably further includes edge pixel identification means for identifying first edge pixels for which both the vertical-direction gradient quantity and the horizontal-direction gradient quantity or the gradient magnitude is greater than or equal to a first threshold, wherein the gradient direction identifying means identifies a gradient direction for the first edge pixels identified by the edge pixel identification means and regards and identifies pixels that are not the first edge pixels as having null direction.

The first edge pixel is a pixel forming a part (edge) of the image data at which brightness changes abruptly. More specifically, the first edge pixel is a pixel for which both the vertical-direction gradient quantity and the horizontal-direction gradient quantity or the gradient magnitude is greater than or equal to a predetermined first threshold.

The purpose of extracting the first edge pixels is to enable the gradient direction identifying means to identify a gradient direction for the extracted first edge pixels and to regard and identify all the pixels that are not the first edge pixels as equally having null direction.

The important information in pattern matching is the gradient direction for the first edge pixels in the edge part.

Therefore, by regarding the gradient direction for pixels of relatively low importance as equally having null direction, the pattern matching efficiency is further improved. The scheme also reduces memory size and processing time in detecting the position in the captured image pointed at with the image capture object, further reducing the cost for the detection of the pointing position.

The image processing device in accordance with the present invention, being provided with the foregoing features, preferably further includes a display device containing pixels a predetermined number of which each include a built-in image capture sensor, wherein the image data is obtained by image capturing by the image capture sensors.

According to the configuration, the image processing device enables a touch input on the display screen of the display device.

The image processing device in accordance with the present invention, being provided with the foregoing features, is preferably such that:

the display device is a liquid crystal display device and includes a backlight illuminating the liquid crystal display device;

the edge pixel identification means identifies second edge pixels for which both the vertical-direction gradient quantity and the horizontal-direction gradient quantity or the gradient magnitude is greater than or equal to a second threshold which is greater than the first threshold;

the gradient direction identifying means identifies a gradient direction for the second edge pixels identified by the edge pixel identification means and regards and identifies pixels that are not the second edge pixels as having null direction; and

the correspondence degree calculation means calculates the correspondence degree from a first number of pixels for which gradient directions of the first edge pixels contained in the matching region match gradient directions contained in a predetermined first model pattern and a second number of pixels for which gradient directions of the second edge pixels contained in the matching region match gradient directions contained in a predetermined second model pattern.

The light entering the built-in image capture sensors in the liquid crystal display device may be a mixture of reflection of the backlight and external light coming from the outside.

When this is the case, it is difficult to separate effects of the reflection of the backlight and effects of the external light coming from the outside from the captured image.

When the image processing device is in dark environment (hereinafter, may be referred to as “in backlight reflection base”), the image obtained from the reflection of the backlight off the image capture object shows a blurred white round figure, for example, for a finger pad. Accordingly, in this case, the first threshold is set to a relatively low value so that the edge pixel identification means can identify the first edge pixels.

On the other hand, when the image processing device is in a bright environment (hereinafter, may be referred to as “in shadow base”), the captured image is blurred (low contrast) if the image capture object (for example, the finger pad) is positioned off the panel surface (non-touch) and sharp (high contrast) if the image capture object is in contact with the panel surface. Therefore, in shadow base, the second threshold is set to a relatively high value so that the edge pixel identification means can identify the second edge pixels in accordance with the second threshold that is more stringent (greater) than the first threshold.

Pattern matching is thus carried out between the image data in which the first edge pixels are identified and the first model pattern predetermined in backlight reflection base and also between the image data in which the second edge pixels are identified and the second model pattern predetermined in shadow base, to obtain the first number of pixels and the second number of pixels. In this case, the correspondence degree calculation means can use, for example, the sum of the first number of pixels and the second number of pixels as the correspondence degree.

Therefore, this single configuration can carry out processes compatible with both backlight reflection base and shadow base without switching the processes between backlight reflection base and shadow base. The invention hence provides an image processing device capable of identifying the position pointed at with the image capture object both under good and poor illumination.

The image processing device in accordance with the present invention, being provided with the foregoing features, preferably further includes touch/non-touch determining means for determining that the image capture object has touched the display device if the correspondence degree calculated by the correspondence degree calculation means has a maximum in excess of a predetermined threshold.

According to the configuration, the image capture object is determined to have touched the display device if a maximum of the correspondence degree exceeds a predetermined threshold. The configuration thus restrains wrong detection which could occur if the image capture object is regarded as having touched the display device whenever the correspondence degree is calculated.

The image processing device in accordance with the present invention, being provided with the foregoing features, preferably further includes touch/non-touch determining means for determining that the image capture object has touched the display device if the correspondence degree calculation means has calculated an correspondence degree in excess of a predetermined threshold.

The touch/non-touch determining means determines that the image capture object is in contact with the display device if the correspondence degree calculation means has calculated an correspondence degree in excess of a predetermined threshold (sufficient correspondence degree), in other words, if image information from which similar features to a model pattern are obtained is input.

Therefore, the configuration can make a decision as to touch/non-touch in the image processing in which the pointing position is identified, without a dedicated device or a processing section being provided to determine touch/ non-touch.

The image processing device in accordance with the present invention, being provided with the foregoing features, preferably further includes touch/non-touch determining means for determining that the image capture object has touched the display device if the edge pixel identification means has identified either the first edge pixels or the second edge pixels.

As mentioned earlier, the light entering the built-in image capture sensors in the liquid crystal display device may be a mixture of reflection of the backlight and external light coming from the outside.

When this is the case, it is difficult to separate effects of the reflection of the backlight and effects of the external light coming from the outside from the captured image.

In backlight reflection base, the image obtained from the reflection of the backlight off the image capture object shows a blurred white round figure, for example, for a finger pad. Accordingly, in this case, the first threshold may be set to a relatively low value so that the touch/non-touch determining means can determine that the image capture object has touched the display device if the edge pixel identification means has identified the first edge pixels.

On the other hand, in shadow base, the captured image is blurred (low contrast) if the image capture object (for example, the finger pad) is positioned off the panel surface (non-touch) and sharp (high contrast) if the image capture object is in contact with the panel surface. Therefore, in shadow base, the second threshold may be set to a relatively high value so that the touch/non-touch determining means can determine that the image capture object has touched the display device if the edge pixel identification means has identified the second edge pixels in accordance with the second threshold that is more stringent (greater) than the first threshold.

Hence, the touch/non-touch detection becomes possible in backlight reflection base and in shadow base by simply setting up the relatively low first threshold and the relatively stringent second threshold. In addition, the determination as to a touch/non-touch can be made in the image processing in which the pointing position is identified, without a dedicated device or a processing section being provided to determine as to a touch/non-touch.

The image processing device in accordance with the present invention, being provided with the foregoing features, is preferably such that the correspondence degree calculation means calculates the correspondence degree if a number of types of corresponding gradient directions in the matching region is greater than or equal to a preset value.

The gradient direction has the general tendency described above. The tendency does not change much with the condition of the image capture object, for example. Therefore, for example, if the number of types of gradient directions is 8, the number of types of matching gradient directions in pattern matching should be close to 8. Hence, if the correspondence degree is calculated when the number of types of corresponding gradient directions in the matching region is greater than or equal to a preset value, the detection of the pointing position requires smaller memory and less processing time. That in turn further reduces the cost for the detection of the pointing position.

The electronic apparatus in accordance with the present invention, being provided with the foregoing features, preferably includes the image processing device.

According to the configuration, the image processing device in accordance with the present invention becomes applicable to general electronic apparatus.

The image processing device may be computer-implemented. When that is the case, the present invention encompasses a control program executed on a computer to realize the image processing device by manipulating the computer as the individual means. The invention also encompasses a computer-readable storage medium containing the program.

### INDUSTRIAL APPLICABILITY

The image processing device in accordance with the present invention is applicable to such devices (e.g., mobile phones and PDAs) that a user can manipulate or enter a command by touching a display on the liquid crystal or like display device. Specifically, the display device may be, for example, an active matrix liquid crystal display device, an electrophoretic display device, a twist-ball display device, a reflective display device using a fine prism film, and a display device using a digital mirror device or like optical modulation element, as well as a field emission display device (FED) and a plasma display device which contain luminance-variable, light-emitting elements, such as organic EL light-emitting elements, inorganic EL light-emitting elements, or LEDs (light-emitting diodes).

1-13. (canceled)

14. An image processing device having a function of calculating a position in a captured image pointed at with an image capture object by using image data for the captured image, said device comprising:
gradient characteristic quantity calculation means for calculating concentration gradient characteristic quantities from the image data;
correspondence degree calculation means for matching a matching region with a predetermined model pattern, the matching region being a region, around a target pixel, containing a predetermined number of pixels, and for calculating a number of pixels for which concentration gradient characteristic quantities contained in the matching region match concentration gradient characteristic quantities contained in the model pattern as an correspondence degree which is a degree of matching of the matching region with the model pattern;
peak pixel search means for searching a search area containing a predetermined number of pixels around the target pixel for a peak pixel which is a pixel for which the correspondence degree calculated by the correspondence degree calculation means is a maximum; and
coordinate calculation means for calculating the position in the captured image pointed at with the image capture object by using the correspondence degree for each pixel in a peak pixel region which is a region containing a predetermined number of pixels centered around the peak pixel found by the peak pixel search means.

15. The image processing device as set forth in claim 14, further comprising coordinate calculation determining means for causing the coordinate calculation means to calculate the pointing position if the coordinate calculation determining means has determined that the peak pixel found by the peak pixel search means is present in a sub-area which contains the same target pixel as does the search area, which contains a predetermined number of pixels that is less than a number of pixels in the search area, and which is also completely enclosed in the search area.

16. The image processing device as set forth in claim 14, further comprising edge pixel identification means for identifying first edge pixels for which the concentration gradient characteristic quantities are greater than or equal to a first threshold, wherein
the correspondence degree calculation means matches the image data for which the first edge pixels have been identified by the edge pixel identification means with a predetermined first model pattern as the model pattern.

17. The image processing device as set forth in claim 16, further comprising a display device containing pixels a predetermined number of which each include a built-in image capture sensor, wherein
the image data is obtained by image capturing by the image capture sensors.

18. The image processing device as set forth in claim 17, wherein:
the display device is a liquid crystal display device and includes a backlight illuminating the liquid crystal display device;
the edge pixel identification means identifies second edge pixels for which the concentration gradient characteristic quantities are greater than or equal to a second threshold which is greater than the first threshold; and
the correspondence degree calculation means matches the image data for which the second edge pixels have been identified by the edge pixel identification means with a predetermined second model pattern as the model pattern and calculates the correspondence degree from a first correspondence degree and a second correspondence degree, the first correspondence degree being obtained by comparing the concentration gradient characteristic quantities contained in the matching region, the concentration gradient characteristic quantities contained in the first model pattern, and the concentration gradient characteristic quantities contained in the second model pattern, the first correspondence degree being a degree of matching of the matching region with the first model pattern, the second correspondence degree being a degree of matching of the matching region with the second model pattern.

19. The image processing device as set forth in claim 17, further comprising touch/non-touch determining means for determining that the image capture object has touched the display device if the correspondence degree calculated by the correspondence degree calculation means has a maximum in excess of a predetermined threshold.

20. The image processing device as set forth in claim 17, further comprising touch/non-touch determining means for determining that the image capture object has touched the display device if the correspondence degree calculation means has calculated an correspondence degree in excess of a predetermined threshold.

21. The image processing device as set forth in claim 18, further comprising touch/non-touch determining means for determining that the image capture object has touched the display device if the edge pixel identification means has identified either the first edge pixels or the second edge pixels.

22. The image processing device as set forth in claim 14, wherein the correspondence degree calculation means calculates the correspondence degree if a number of types of the corresponding concentration gradient characteristic quantities in the matching region is greater than or equal to a preset value.

23. A computer program encoded in a computer-readable medium, the image processing device as set forth in claim 14 being provided with the readable medium, wherein the computer program, when run on a computer, implements functions of the individual means in the image processing device.

24. A computer-readable storage medium containing a control program for an image processing device for operating a computer as the individual means in the image processing device as set forth in claim 14.

25. An electronic apparatus, comprising the image processing device as set forth in claim 14.

26. A method of controlling an image processing device having a function of calculating a position in a captured image pointed at with an image capture object by using image data for the captured image, said method comprising:
the gradient characteristic quantity calculation step of calculating concentration gradient characteristic quantities from the image data;
the correspondence degree calculation step of matching a matching region with a predetermined model pattern, the matching region being a region, around a target pixel, containing a predetermined number of pixels, and of calculating a number of pixels for which concentration gradient characteristic quantities contained in the matching region match concentration gradient characteristic quantities contained in the model pattern as an correspondence degree which is a degree of matching of the matching region with the model pattern;
the peak pixel search step of searching a search area containing a predetermined number of pixels around the target pixel for a peak pixel which is a pixel for which the correspondence degree calculated by the correspondence degree calculation means is a maximum; and
the coordinate calculation step of calculating the position in the captured image pointed at with the image capture object by using the correspondence degree for each pixel in a peak pixel region which is a region containing a predetermined number of pixels centered around the peak pixel found in the peak pixel search step.
